(19) United States
(12) Patent Application Publication
(10) Pub. No.: US 2004/0006745 A1
(43) Pub. Date: Jan. 8, 2004

(54) Methods, apparatuses, system, and articles for associating metadata with datastream

(76) Inventors: Wico van Helden, Hendrick Ido Ambacht (NL); Andries Japhet den Haan, Flowery Branch, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 09/972,673

(22) Filed: Oct. 5, 2001

Related U.S. Application Data
(60) Provisional application No. 60/316,555, filed on Aug. 31, 2001.

(51) Int. Cl. G06F 15/00

(52) U.S. Cl. 715/516; 715/522; 715/513

(57) ABSTRACT

The disclosed methods, apparatuses, system, and articles can be used to associate metadata with a datastream, or to use metadata in the datastream to transform it into a different datastream. Through the use of metadata, the datastream can be used for purposes other than rendering a presentation. The metadata can also be used by a computer programmer to develop or modify software because the metadata can include extensive information regarding the application, data definition, user interface definition, and data used to render a datastream even though such information is not normally present in the datastream.

### CROSS-REFERENCE TO RELATED APPLICATION

This nonprovisional patent application claims priority benefits under 37 C.F.R. §1.53(c) and 35 U.S.C. §119(e) to provisional application No. 60/316,555 filed Aug. 31, 2001, naming Wico van Helden and Andries Japhet den Haan, citizens of the Netherlands, as inventors.

### FIELD OF THE INVENTION

The invention relates to technology useful in the performance of computer programming, and more particularly, to a technology that associates metadata with elements of a datastream so that programming of a device in a computing environment can be more readily performed. The metadata describes the context, including source, meaning, permissible values, etc., of the datastream elements and can thus be used to assist a programmer or a computer in determining the nature of the data. In addition, the metadata can be associated with a presentation datastream to extend the possible uses of the datastream beyond merely rendering a presentation.

### BACKGROUND INFORMATION

FIG. 1 shows a previous system 10 that comprises computing environments 12, 14. An application 16 is loaded and executed in the computing environment 12. The application 16 can be one that renders a presentation so that a user can interact with it. Other than the requirement that the application 16 generates a datastream 24 when executed, the particular purpose or function performed by the application 16 is not important to the disclosure.

In addition to the application 16, the computing environment 12 stores the data definition 18, user interface definition 20, and data 22, which are used by the application 16 to generate the datastream 24. More specifically, as the application 16 executes, it uses the data definition 18 to retrieve the data 22 from a data storage unit within the computing environment 12. The application 16 processes the data 22 and ultimately generates additional data 22 that it stores in its data storage unit for use in rendering a presentation 26. For example, the application 16 may be such that when executed it generates a total all debts owed by a particular individual for a particular month, and stores the total debt as data 22 to be included in a presentation to a user. To render the presentation 26, the application 16 retrieves the user interface definition 20 from its data storage unit, and uses such user interface definition to generate computer instructions for the presentation. The application 16 combines the instructions with the data 22. The application 16 generates a datastream 24 including the computer instructions and data for rendering the presentation 26, and transmits this datastream 24 to the computing device 28. The computing device 28 receives the computer instructions and data in the datastream 24 and renders the presentation 26 based thereon. If a user of the computing device 28 so desires, the user can operate the computing device 28 to generate a datastream 30 to request additional action from the application 16. Such action might include a request for further execution of the application 16 to store data input by the user with the computing device 28, to retrieve data from the computing environment 12, and/or to generate additional data for presentation on the computing device 28, for example. The application 16 receives the datastream 30 and executes the application 16 to carry out the action specified by the datastream 30. The computing environment 14 can thus be operated so as to be interactive with the computing environment 12.

It should be appreciated that the datastream 24 received by the computing device 28 contains no or limited information regarding the application 16, data definition 18, user interface definition 20, and data 22 used in its generation. Therefore, the use of the datastream 26 for purposes other than rendering the presentation 26 is significantly limited because the meaning of the computer instructions and data for the presentation 26 cannot generally be determined from the datastream 24. It would be desirable if the datastream 24 could be made useful for other purposes. For example, suppose a programmer wanted to create an application to use the datastream 24 to perform the function of automatically generating a letter to notify a debtor of current charges for a particular month. Although the data needed to generate this letter may be present in the presentation datastream 24, there was heretofore no known efficient way to extract it. It would be desirable to make it possible to efficiently use data present in the datastream 24 for purposes other than merely rendering the presentation 26.

### SUMMARY OF THE INVENTION

The present invention, in its various aspects, overcomes the problems of previous technologies noted hereinabove.

A first method of the invention comprises associating metadata with a presentation datastream. The first method can also comprise using the metadata to extract at least one element from the presentation datastream to use it for a purpose other than to render a presentation, such as processing or storing elements contained therein, whether or not the datastream is used for rendering a presentation. The metadata can identify an application that generated the presentation data, the memory location of such application, and/or its purpose. As another possibility, the metadata can identify a data definition defining data used to generate the presentation datastream. Accordingly, the metadata can be used to identify a field length of data, the type of data, a variable name associated with the data, and/or permissible values of the data including a range or group of permissible values. Furthermore, the metadata can identify a user interface definition of the presentation datastream. For example, the user interface definition can include a name of the data rendered on a user interface, and the metadata can identify this name. As another example, the user interface definition can identify screen position of data on a user interface display screen, and the metadata can identify the screen position. For example, the screen position can be indicated by character row and column on the user interface display screen, and the metadata can identify the row and column of respective data. Moreover, the user interface definition can include a variable name associated with a data value, and the metadata can identify the variable name and data value. The metadata can identify a screen to which the presentation datastream pertains. Furthermore, the presentation datastream can include an instruction and data, the instruction indicating the display position of the data in a presentation, and the data indicating at least one character for rendering in the presentation, in which the metadata is associated with the instruction and data. The first method can further comprise obtaining the metadata. The metadata can be obtained by using a mapping of elements in the presentation datastream to corresponding metadata. Alternatively, the metadata can be obtained by using a mapping of elements in the presentation datastream to corresponding metatags, and applying the corresponding metatags to the elements of the presentation datastream. The metadata can be included in the datastream in the form of an eXstensible Markup Language (XML) document, for example. The first method can comprise the additional step of using the metadata to modify at least one of an application, a user interface definition, and a data definition, used to generate the presentation datastream. Furthermore, the first method can comprise developing or modifying an application through the use of the metadata to permit such application to use one or more elements of the datastream.

A second method of the invention comprises using metadata in a first datastream in a context of a first computing environment to map at least one element of the first datastream to a corresponding element of a second datastream in a context of a second computing environment. The first and second datastreams can be presentation datastreams containing elements for rendering a presentation. For example, the first datastream can be one of VT52, VT100, VT220-78, VT220-8, VT320-7, VT320-8, VT420-7, VT420-8, VT525-7, VT525-8, 3270, 5250, 3270E, 5250E, TN3270E, TN5250E, TDG, SCO ANSI, BBS ANSI, AT 386, AIXTERM, WYSE 50, WYSE 60, TVI 925, and TVI 950 terminal datastreams, and the second datastream can be one of HTTP, SGML, HTML, DHTML, XML, WML, WAP, tagging language, and byte code datastreams. Through the use of the metadata, the second datastream can be used for a purpose other than to render a presentation, in addition to or in lieu of rendering such presentation. For example, the second datastream can be provided to an application for processing and/or can be provided to a data storage unit for storage. The presentation datastreams can include at least one instruction and data. The instruction can indicate a screen display position of the data in a presentation, and the data can indicate at least one character for rendering in the presentation at the screen position indicated by the instruction. The metadata can be used to map the instruction and data of the first datastream to corresponding instruction and data of the second datastream. The metadata can identify an application that generated the first presentation datastream, a memory location of such application, and/or the application's purpose. As another possibility, the metadata can identify a data definition defining data used to generate the first presentation datastream, including a field length of the data, type of data, a variable name associated with the data, and/or permissible values for the data including a range or group of permissible values. The metadata can identify a user interface definition, including a variable name of data to be rendered in a presentation based on the second datastream, a screen position of data on a user interface display screen in a presentation to be rendered by the second datastream, a variable name associated with a data value, the data value, and/or a presentation screen rendered with the second datastream.

A third method comprises using metadata to extract elements of a presentation datastream. The third method also comprises using the extracted elements by processing or storing the extracted elements in addition to rendering the presentation.

A fourth method comprises generating a first datastream in a context of a first computing environment, associating metadata with the first datastream to produce a second datastream, and transmitting the second datastream to a second computing environment. The fourth method also comprises receiving the second datastream at the second computing environment, transforming the second datastream into a third datastream using the metadata, the third datastream in the context of a third computing environment, and transmitting the third datastream to the third computing environment. The first and second datastreams can be presentation datastreams. The second datastream can be used for a purpose other than to render a presentation. For example, the third datastream can be provided to an application for processing and/or can be provided to a data storage unit for storage, whether or not such third datastream is used to render a presentation. The first datastream can be one of VT52, VT100, VT220-78, VT220-8, VT320-7, VT320-8, VT420-7, VT420-8, VT525-7, VT525-8, 3270, 5250, 3270E, 5250E, TN3270E, TN5250E, TDG, SCO ANSI, BBS ANSI, AT 386, AIXTERM, WYSE 50, WYSE 60, TVI 925, and TVI 950 terminal datastreams, and the third datastream can be one of HTTP, SGML, HTML, DHTML, XML, WML, and WAP datastreams. The presentation datastreams can include at least one instruction and data, the instruction indicating a screen display position of the data in a presentation, and the data indicating at least one character for rendering in the presentation at the screen position indicated by the instruction. The metadata can be used to map the instruction and data of the second datastream to corresponding instruction and data of the third datastream.

A fifth method comprises associating metadata with an interactive datastream. The interactive datastream can be generated by first and second computing environments communicating with one another. The metadata can be associated with at least one element of the datastream to identify the element so as to be able to transform the element from a context of one computing environment to a context of the other computing environment. The first computing environment can execute an application to generate at least one element of the datastream, and the second computing environment can render a presentation using the element of the datastream. Alternatively, or in addition, the first computing environment can execute a first application to generate at least one element of the datastrearn, and the second computing environment can execute a second application using the element of the datastream. As another possibility, the first computing environment can execute an application to generate at least one element of the datastream, and the second computing environment can store the element in a data storage unit.

A sixth method comprises using metadata in a datastream to modify at least one of an application, a user interface definition, and a data definition, used to generate the datastream. The datastream can comprise a presentation datastream. The metadata can identify the application, user interface definition, and/or data definition. Alternatively, or in addition, the metadata can comprise identify the application, user interface definition, and/or data definition.

A seventh method comprises developing an application using metadata in a datastream. The datastream can comprise a presentation datastream. The metadata can identify the application, which may or may not be an application used to generate the datastream. The metadata can identify the application, user interface definition, and/or data definition used to generate the datastream. Alternatively, or in addition, the metadata can comprise the application, user interface definition, and/or data definition used to generate the datastream.

An eighth method of the invention comprises modifying an application using the metadata in datastream. The datastream can comprise a presentation datastream. The modified application may or may not be the application that generated the datastream. The metadata can identify the application, user interface definition, and/or data definition used to generate the datastream. Alternatively, or in addition, the datastream can comprise the application, user interface definition, and/or data definition used to generate the datastream.

A first apparatus of the invention comprises a computing environment that executes a metadata module to associate metadata with a presentation datastream. The metadata module can associate the metadata with the presentation datastream to permit another computing environment to use the element from the presentation datastream for a purpose other than to render a presentation, whether or not such presentation is rendered. For example, the metadata module can associate the metadata with the presentation datastream so that at least one element of the presentation datastream can be used by an application executed in the other computing environment. Alternatively, or in addition, the metadata module can associate the metadata with the presentation datastream so that at least one element of the presentation datastream can be stored in a data storage unit of the other computing environment. The metadata can identify an application that generated the presentation data, its memory location, or its purpose. Moreover, the metadata can identify a data definition defining the data used to generate the presentation datastream. Accordingly, the metadata can identify a field length of data, type of data, variable name associated with the data, and/or permissible values for the data including a range or group of permissible values. Furthermore, the metadata can identify a user interface definition for the data. Accordingly, the metadata can identify a variable identifying the data in the datastream to be rendered on the user interface, a screen position of data on a user interface display screen, a screen to which the presentation datastream pertains, and/or a rendering instruction and/or data contained within the presentation datastream. The metadata module can obtain the metadata from a memory device in the computing environment in which the metadata module is executed. Alternatively, the metadata module can generate the metadata using metatags and a mapping of elements of the presentation datastream to corresponding metatags, and applying the corresponding metatags to corresponding data in the presentation datastream. The metadata can be included with the presentation datastream in an eXstensible Markup Language (XML) document, for example.

A second apparatus of the invention comprises a computing environment that receives a first datastream having metadata. The computing environment comprises a metadata interpreter using the metadata in the first datastream to map at least one element of the first datastream to a corresponding element of a second datastream. The second datastream is used for a purpose other than to render a presentation, such as use by an application to process the data or for storage in a data storage unit, whether or not the second datastream is used to render a presentation. The first and second datastreams can be presentation datastreams. For example, the first datastream can be one of VT52, VT100, VT220-78, VT220-8, VT320-7, VT320-8, VT420-7, VT420-8, VT525-7, VT525-8, 3270, 5250, 3270E, 5250E, TN3270E, TN5250E, TDG, SCO ANSI, BBS ANSI, AT 386, AIXTERM, WYSE 50, WYSE 60, TVI 925, and TVI 950 terminal datastreams, and the second datastream can be one of HTTP, SGML, HTML, DHTML, XML, WML, WAP, tagging language, and byte code datastreams. The presentation datastreams can include at least one instruction and data, in which the instruction indicates a screen display position of the data in a presentation, and the data indicates at least one character for rendering in the presentation at the screen position indicated by the instruction. The metadata can be used to map the instruction and data of the first datastream to corresponding instruction and data of the second datastream. The metadata can identify an application that generated the first datastream, its memory location, and/or a purpose of the application. Furthermore, the metadata can identify a data definition defining data used to generate the first datastream. Accordingly, the metadata can identify a field length of the data, a data type, a variable name associated with the data, and/or permissible values for the data including a range or group of values. As yet another possibility, the metadata can identify a user interface definition. Accordingly, the user interface definition can identify a variable name of data to be rendered in a presentation based on the second datastream, a screen position of data on a user interface display screen, a variable name associated with a data value, and/or a presentation screen to be rendered with the second datastream.

A system of the invention receives a first datastream. The system comprises first and second computing environments. The first computing environment executes a metadata module to associate metadata with the first datastream to generate a second datastream. The second computing environment is coupled to receive the second datastream from the first computing environment. The second computing environment executes a metadata interpreter to map the metadata associated with at least one element of the second datastream to at least one corresponding element of a third datastream, in the generation of the third datastream. The system can further comprise a computing device coupled to receive the third datastream and rendering a presentation based thereon. The first datastream can be generated by a host computer, and the computing device can render a presentation that emulates a terminal device corresponding to the first datastream. For example, the first datastream can be one of VT52, VT100, VT220-78, VT220-8, VT320-7, VT320-8, VT420-7, VT420-8, VT525-7, VT525-8, 3270, 5250, 3270E, 5250E, TN3270E, TN5250E, TDG, SCO ANSI, BBS ANSI, AT 386, AIXTERM, WYSE 50, WYSE 60, TVI 925, and TVI 950 terminal datastreams, and the third datastream can be one of HTTP, SGML, HTML, DHTML, XML, WML, WAP, tagging language, and byte code datastreams. The first datastream can be a presentation datastream, although the third datastream need not be used to render a presentation, a major advantage over previous systems. For example, the third datastream can be processed by an application executed on a computing device for a purpose other than to render a presentation, and/or can be supplied to a data storage unit for storage of data contained therein, in addition to or in lieu of use in rendering a presentation.

A first computer-readable medium has a metadata module for associating metadata with a presentation datastream. The metadata module can use the metadata to extract at least one element from a presentation datastream for use for a purpose other than to render a presentation, whether or not such datastream is used to render a presentation. The computer-readable medium can also store metadata for use by the metadata module. The metadata can identify an application that generated the presentation data, its memory location, and/or its purpose. As another possibility, the metadata can identify a data definition defining data used to generate the presentation datastream, a field length of data stored in the data storage unit, a data type of the presentation data stored in the data storage unit, a variable name associated with data, and/or permissible values for the data including a range of values or group of permissible values. The metadata can identify a user interface definition for the presentation data, a variable name of the data rendered on the user interface, a data value, a screen position of data on a user interface display screen, a screen to which the presentation data pertains, and/or an instruction and data contained within the datastream, for example. The metadata module can obtain the metadata using a mapping of elements in the presentation datastream to corresponding metadata. Alternatively, the metadata module can obtain the metadata by mapping of elements in the presentation datastream to corresponding metatags, and applying the corresponding metatags to the elements of the presentation datastream.

A second computer-readable medium comprises a metadata interpreter using metadata in a first datastream in a context of a first computing environment to map at least one element of the first datastream to a corresponding element of a second datastream in a context of a second computing environment. The second datastream can be used for a purpose other than to render a presentation, such as providing the datastream to an application for processing and/or a data storage unit for storage, in addition to or in lieu of rendering the presentation. The first and second datastreams can be presentation datastreams. For example, the first datastream can be one of VT52, VT100, VT220-78, VT220-8, VT320-7, VT320-8, VT420-7, VT420-8, VT525-7, VT525-8, 3270, 5250, 3270E, 5250E, TN3270E, TN5250E, TDG, SCO ANSI, BBS ANSI, AT 386, AIXTERM, WYSE 50, WYSE 60, TVI 925, and TVI 950 terminal datastreams, and the second datastream can be one of HTTP, SGML, HTML, DHTML, XML, WML, WAP, tagging language, and byte code datastreams. The presentation datastreams can include at least one instruction and data. The instruction can indicate a screen display position of the data in a presentation, and the data can indicate at least one character for rendering in the presentation at the screen position indicated by the instruction. The metadata can be used to map the instruction and data of the first datastream to corresponding instruction and data of the second datastream. The metadata can identify an application that generated the first presentation datastream, its memory location, or its purpose. As another possibility, the metadata can identify a data definition defining data used to generate the first presentation datastream. The metadata can identify a field length of the data, type of data, a variable name associated with the data, and/or permissible values for the data including a range or group of permissible values. Furthermore, the metadata can identify a user interface definition. Such user interface definition can include a variable name of data to be rendered in a presentation based on the second datastream, screen position of data on a user interface display screen, such as character row and column, a variable name, a data value associated with the variable name, and/or a presentation screen rendered by the second datastream.

Details of the construction and operation of the invention are more fully hereinafter described and claimed. In the detailed description, reference is made to the accompanying drawings, forming a part of this disclosure, in which like numerals refer to like parts throughout the several views.

### BRIEF DESCRIPTION OF THE DRAWINGS

FIG. 1 is a block diagram of a previous system for generating a datastream;

FIG. 2 is a block diagram of a system in accordance with the invention that has a metadata module for associating metadata with a datastream, and a metadata interpreter that uses the metadata to transform the datastream into a different datastream;

FIG. 3 is a data flow diagram of the system of FIG. 2;

FIG. 4 is a data flow diagram of the system of FIG. 2 in which the datastream flows in a reverse sense relative to the data flow of FIG. 3;

FIG. 5 is a method performed by the metadata module to associate metadata with a datastream;

FIG. 6 is a method performed by the metadata interpreter to use the metadata to map element(s) of a first datastream to corresponding element(s) of a second datastream;

FIG. 7 is a method performed by the metadata interpreter to associate metadata with a datastream flowing in a reverse sense relative to the methods of FIGS. 5 and 6;

FIG. 8 is a method performed by the metadata module to use the metadata to transform the datastream from the metadata interpreter into a different datastream flowing in the reverse sense relative to the methods of FIGS. 5 and 6;

FIG. 9 is a first method of obtaining metadata for association with a datastream;

FIG. 10 is a data flow diagram corresponding to the method of FIG. 9;

FIG. 11 is a second method of obtaining metadata for association with a datastream;

FIG. 12 is a data flow diagram indicating data flow in the metadata module in accordance with the method of FIG. 11;

FIG. 13 is a third method of obtaining metadata for association with a datastream;

FIGS. 14-19 indicate a relatively specific example of data flow in the invented system, and how the metadata can be used by an application or stored in a data storage unit, in addition to use in rendering a presentation;

FIGS. 20-22 indicate a relatively specific example of data flow in a reverse sense to that of FIGS. 14-19;

FIG. 23 is a relatively specific example of the invented system;

FIG. 24 is a computer-readable medium storing the metadata module; and

FIG. 25 is a computer-readable medium storing the metadata interpreter.

FIG. 26 is a flowchart of a method for using metadata from a datastream to modify an application, user interface definition, or data definition;

FIG. 27 is a flowchart of a method for developing an application using metadata from a datastream; and

FIG. 28 is a flowchart of a method for modifying an application using metadata from a datastream.

### DESCRIPTION OF THE PREFERRED EMBODIMENTS

### Definitions

“And/or” means either or both of the things immediately preceding and succeeding the term.

“Application definition” is data pertaining to an application executed by a computing environment to generate a datastream. Such application definition can include the identity and/or memory location of the corresponding application in the computing device, as well as data that identifies to a user the purpose of the application program, for example.

“Context” refers to one or more parameters that pertain to an element of a datastream with respect to the computing environment that generated it, the computing environment receiving it, or both. Such parameters can include application definition, data definition, user interface definition, instruction and data values associated with such element, as well as its generation or use.

“Coupled” refers to joining a computing environment, computing device, and/or data storage unit so as to permit a datastream to be transmitted from one to another. Such datastream can be in electronic form and transmitted between coupled elements by a conductive line such as a wire or cable or other waveguide, or via wireless transmission of signals through air or other media, or space, for example. Alternatively, such datastream can be in optical form and transmitted via optical fiber or other optical waveguide, or by transmission of such optical signals through air, space, or other media, for example.

“Computer-readable medium” includes mechanical, electronic, magnetic, magneto-electronic, micro-mechanical, or optical data storage media, for example. The computer-readable medium can include compact-disk read-only memory (CD-ROM), digital versatile disk (DVD), magnetic media such as a floppy disk, diskette, cassette, hard-disk storage units, tape or other data storage medium. The computer readable medium can include a random-access memory (RAM), read-only memory (ROM), programmable read-only memory (PROM), and/or electrically-erasable read-only memory (EEPROM). The computer-readable medium can also include punchcards, magnetic strips, magnetic tapes, etc. Such memory can have a byte storage capacity from one byte to Terabytes or more, for example. The computer-readable medium can be loaded and executed by a computing device.

“Computing device” is a computer or server capable of processing input data to generate output data through execution of computer program instructions. In the disclosed aspects of the invention, the computing device may be capable of executing an application, metadata module, and/or metadata interpreter module. In the specific contexts of this disclosure, a computing device is a device capable of rendering a presentation, executing an application, or storing or retrieving data in a data storage unit. Such computing device can be a mainframe, miniframe, or super-computer, server, personal computer, laptop computer, personal digital assistant (PDA), or other device. The computing device can also be capable of interacting with another computing device or environment, or a data storage unit to retrieve or store data. The operating system used by the computing device can be OS, AS/400, S/390, zSeries, or iSeries systems from IBM® Corporation, for example. Options for the computing device hardware are commercially available from Sun® Corporation, Santa Clara, Calif., Hewlett-Packard® corporation, Santa Clara, Calif., Dell® Corporation, Roundrock, Tex., Compaq® Corporation, and many other sources. Other possible operating systems include DOS, UNIX, LINIX, Solaris, or Apache systems. The computing device can use a datastream to render a presentation. For example, the computing device can use UNIX VT52, VT100, VT220-78, VT220-8, VT320-7, VT320-8, VT420-7, VT420-8, VT525-7, VT525-8, 3270, 5250, 3270E, 5250E, TN3270E, TN5250E, TDG, SCO ANSI, BBS ANSI, AT 386, AIXTERM, WYSE 50, WYSE 60, TVI 925, and TVI 950, hypertext transport protocol (HTTP), standard generalized mark-up language (SGML), hypertext mark-up language (HTML), dynamic HTML (DHTML), extensible mark-up language (XML), wireless markup language (WML), wireless application protocol (WAP), tagging language, and byte code datastreams. The computing device can generate a datastream in accordance with transfer control protocol/internet protocol (TCP/IP) or other protocol. The computing device can be configured to encode or decode the datastream for transmission or reception via a network using Ethernet, HTTP, HTML, XML, WML, WAP, in accordance with the specifications of respective layers of the IEEE 802.x standards of the ISO/OSI reference model, for example.

“Computing environment” refers to a computing device and its operating system or environment.

“Data storage unit” refers to a device capable of storing data, such as a random-access memory, hard-disk drive(s), tape or other storage medium type for the storage of data. The data storage unit can be implemented as multi-hard-disk storage drive coupled to a database server, for example the data storage unit can be controlled with commercially-available software packages such as Oracle 9i from Oracle® Corporation, Redwood City, Calif. The computing device can communicate with the data storage unit through an application program interface (APD such as Java DataBase Connectivity (JDBC) or Open DataBase Connectivity (ODBC), for example.

“Data definition” defines parameters of data stored in the data storage unit. The data definition can be identified and located by the computing device with a filename and/or memory location. The data definition can include the length (e.g., in bits or bytes), type (e.g., numeric, alpha-numeric, alphabetic), name or variable, and permissible values of the data (e.g., date ranges, months of year, year ranges, existing zip codes, number of decimal places, upper case only, lower-case only, etc.).

“Datastream” refers to an element such as an instruction or data, that travels from one computing device, environment, or data storage unit, to another. The datastream can travel via a network such as the Internet, an intranet, metropolitan area network (MAN), local area network (LAN), Wide Area Network (WAN), etc. The datastream can be encoded for transport via the network using transport control protocol/internet protocol (TCP/IP), for example. The datastream can be encoded as a terminal protocol, hypertext mark-up language (HTML), extensible mark-up language (XML), Wireless Mark-up Language (WML), Wireless Access Protocol (WAP) or other language. Such language can include a computer-readable code that can be used to generate a presentation within a web browser or other application executable by a computing device or environment or data storage unit. The datastream content is not generally limited, and can comprise data, text, image file(s), sound file(s), video file(s), program file(s), one or more web page documents and/or an application or computer program.

“File” refers to a set or collection of data.

“Graphical user interface” or “GUI” refers to an interface provided by a computing device through its input and output units that permits a person to interact with the computing device to control such computing device.

“Input device” refers to a keyboard, mouse, joystick, wand or any other device that can be operated by a user to input commands or data into the computing device.

“Instruction” refers to computer code that is executable by a processor, such as those of the computing device or environment or data storage unit.

“Metadata” is data that describes an element of a datastream or parameters that pertain to such element. The metadata can identify elements of a presentation datastream, or a data definition, user interface definition, application definition, or other data used in the generation of the datastream. The metadata permits a user or computing device to determine what a datastream element is, as well as its characteristics, origin, and resources involved in the generation of such element. The metadata can be in the form of metatags associated with respective elements of the datastream, as used in XML, for example.

“Module” refers to computer code or an object executable by a processor of a computing device or computing environment.

“Network” can be an intranet, local area network (LAN), wide area network (WAN), metropolitan area network (MAN), “the Internet”, a virtual private network (VPN), or other network, for example. The “network” establishes communication between two or more computing devices or environments, or a data storage unit. Such network communication can be in accordance with the specifications of IEEE 802.x relating to the ISO/OSI reference model.

“Operating system” is a computer program that enables a processor within a data storage unit or computing device or environment, to communicate with other components of such apparatuses, such as memory, input or output devices, etc. Such operating systems can include Microsoft® Windows XP, Windows 2000™, Windows NT™, Windows 95™, Windows 98™, or disc-operating system (DOS), for example. Such operating systems can also include the Java-based Solaris® operating system by Sun Microsystems, the UNIX® operating system, LINUX® operating system. Furthermore, the operating system can comprise an OS, AS/400, S/390, zSeries, iSeries system, and others.

“Output device” can comprise a flat-panel transistor display or liquid crystal display (LCD), a cathode ray tube (CRT), or other device for generating a display based on output data generated by a computing device. In addition to the display unit, or as an alternative thereto, the output unit can comprise one or more acoustic speakers or other device for generating sound based on the output data.

“Programmer” refers to a person that programs or modifies computer programs or data stored in the computing device, computing environment, or data storage unit.

“Processor” can be a microprocessor such as a Pentium® series microprocessor commercially-available from Intel® Corporation, a microcontroller, programmable instruction array (PLA), field programmable gate array (FPGA), programmable instruction device (PLD), programmed array instruction (PAL), or other device.

“Provide access” means to pass control over data from one software module to another, or to transmit such data from one software module to another.

“Presentation” or “presentation space” refers to the rendering of data by a computing device so as to be perceptible by a user, such as through the generation of a display (e.g., static, video, or animated), through generation of sound, or other means.

“Server” is one example of a computing device operating on the Internet or other network environment that responds to commands from a client. Such server can be commercially from numerous sources such as Alpha Microsystems®, Santa Ana, Calif., Intel® Corporation, Hewlett-Packard® Corporation, Sun Microsystems®, Inc. capable of serving data or files to client applications via hypertext-transport protocol (HTTP). The server can execute server-based applications such as CGI scripts, or Java® servlets, or Active server pages, for example.

“(s)” at the end of a word means “one or more.” For example, “part(s)” means “one or more parts.”

“Transmission media” includes an optical fiber, wire, cable, or other media for transmitting data in optical or electric form.

“Universal Resource Locator” or “URL” is the address of a device such as computing device accessible via the Internet or other network.

“User” generally refers to a human operator of a computing device.

“User interface definition” defines the presentation space to be rendered by the computing device. This may include data identifying a display screen, defining position of data on a display screen generated by the computing device such as by pixel or character row and column, data identifying the name or variable associated with presentation data, data defining the length of presentation data, etc. In addition, the user interface definition can include a name or moniker identifying the particular screen to be rendered, and computer instructions indicating how a computing environment is to display the data, for example.

“Web browser” or “browser” is a computer program that has the capability to execute and display an HTML and/or extensible mark-up language (XML) document, for example, and that interacts with the computing device via a network. For example, the web browser can be Internet Explorer® version 5 program available from Microsoft® Corporation, Redmond, Wash., or Communicator® version 4.5 program available from Netscape, Inc. “Web browser” also encompasses within its meaning HTML and/or XML viewers such as those used for personal digital assistants (PDAs).

### General System and Method for Associating Metadata with Datastream

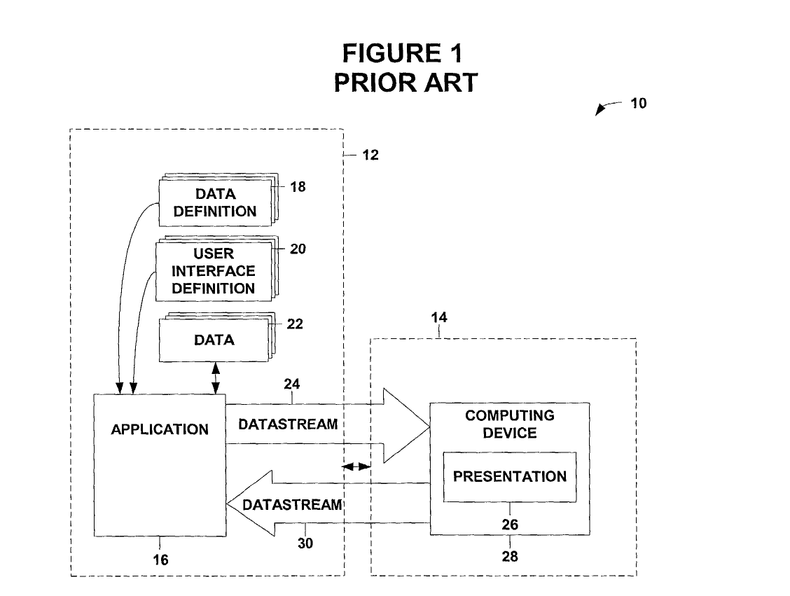

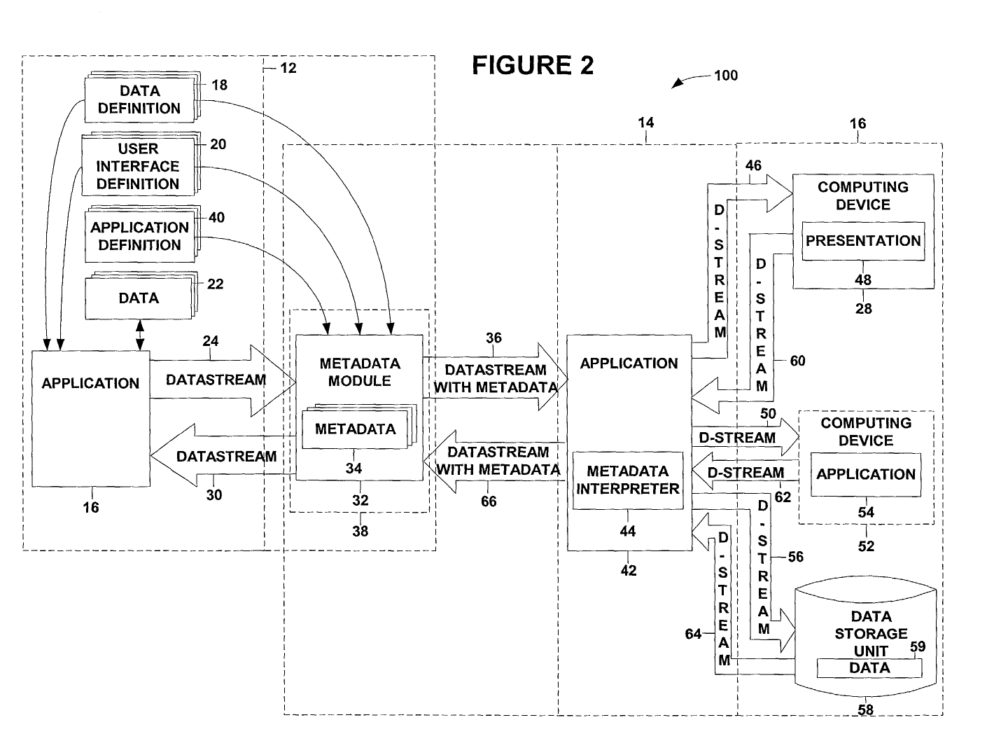

FIG. 2 is a system 100 of the invention that is similar in many respects to the system 10 of FIG. 1. The application 16 is executed in the computing environment 12 and uses the data definition 18, user interface definition 20, and data 22, to generate a presentation datastream 24. Importantly, unlike the system 10 of FIG. 1, the system 100 comprises a metadata module 32. The metadata module 32 associates metadata 34 with respective data in the datastream 24 to produce the datastream 36. The metadata module 32 can be loaded with the metadata 34 in advance of receiving the datastream 24. Alternatively, the metadata module 32 can generate the metadata 34 using the data definition 18, the user interface definition 20, and/or an application definition 40, from the computing environment 12. The metadata module 32 can be loaded and executed in either or both of the computing environments 12 or 14, or alternatively, in a separate computing environment 38.

From the metadata module 32, the datastream 36 with metadata 34 is sent to application 42. Importantly, through the use of the metadata interpreter 44 in the application 42, the application can use the metadata 34 in the datastream 36 to extract the elements from the datastream to generate a different datastream 46 for rendering a presentation 48. For example, the original datastream 26 can be in the form of a UNIX VT52, VT100, VT220-78, VT220-8, VT320-7, VT320-8, VT420-7, VT420-8, VT525-7, VT525-8, 3270, 5250, 3270E, 5250E, TN3270E, TN5250E, TDG, SCO ANSI, BBS ANSI, AT 386, AIXTERM, WYSE 50, WYSE 60, TVI 925, and TVI 950 terminal protocol. Using the metadata 34 in the datastream 36, the metadata interpreter 44 can transform such datastream into an HTTP, SGML, HTML, XML, WML, WAP, or other byte code datastream 46 to render a presentation 48 including the same data as originally contained in the datastream 24. More specifically, to accomplish transformation from the datastream 36 to the datastream 46, the metadata interpreter 44 can use the metadata 34 in the datastream 36 to map its elements to variables used by the application 42. The application 42 can then generate the datastream 46 and supply this to the computing device 28 to render the presentation 48.

Moreover, the metadata interpreter 44 can use the metadata 34 to map its data to variables to a different application 54, possibly executed by a different computing device 52. The application 54 can process the received data to generate other data that can be unrelated to rendering a presentation. Furthermore, the metadata interpreter 44 can use the metadata 34 to map the data in the datastream 36 to variables used to store such data in a data storage unit 58. Hence, through the use of the metadata 34, the metadata interpreter 44 can extend the use of the data contained in the original datastream 24 to purposes other than merely rendering a presentation, a feature that provides a major advantage over previous technologies.

Another extension of the capabilities made possible by the metadata interpreter 44 through the use of the metadata 34 is to permit the application 42 to accept data from the datastream 24 into its variables to process such data. The processed data can then be output to the computing device 28 in datastream 46 to render the presentation 48, or mapped to variables in datastream 50 to permit its use by the application 54, or mapped to variables in datastream 56 for storage in the data storage unit 58.

Moreover, the system 100 can use the metadata 34 in the reverse sense to map data supplied by the computing device 28, the application 54, or the data storage unit 58, to the variables used by the application 16. For example, the datastream 24 can be such as to render an HTTP form with fields for data entry on the computing device 28. A user can input data in the entry fields and submit the form to the metadata interpreter in the datastream 30. The metadata interpreter 44 maps the data in the form fields to corresponding metadata 34 originally received via the datastream 36, and supplies this data with associated metadata to the metadata module 32. The metadata module 32 uses the received metadata 34 to map corresponding data to respective variables used by the application 16, and outputs these variables and respective data to the application 16 via the datastream 60. The application 16 can be executed in the computing environment 12 to process the data 22. A similar process can be used by the application 54 to supply data to the application 16. More specifically, the computing device 52 can execute the application 54 to generate data associated with respective variables in the datastream 62 supplied to the metadata interpreter 44. The metadata interpreter 44 uses the variables to obtain corresponding metadata 34 and supplies this data and metadata in the datastream 66 to the metadata module 32. The metadata module 32 uses the metadata 34 to map the data in datastream 66 to corresponding variables use by the application 16. The metadata module 32 generates the datastream 30 to provide the data along with respective variables used by the application 16. Similarly, the data storage unit 58 can provide respective variables and data to the application 42 via datastream 64. The metadata interpreter 44 uses the data variables to map corresponding metadata 34 to the variables and data from the data storage unit 58. The metadata interpreter 44 supplies the variables, data, and metadata 34 to the metadata module 32 that uses the metadata to map the data to variables used by the application 16. The application 16 can use the variables to process respective data, such as by operating on the data or storing the data in its own data storage unit.

### General Data Flow in the Invented System

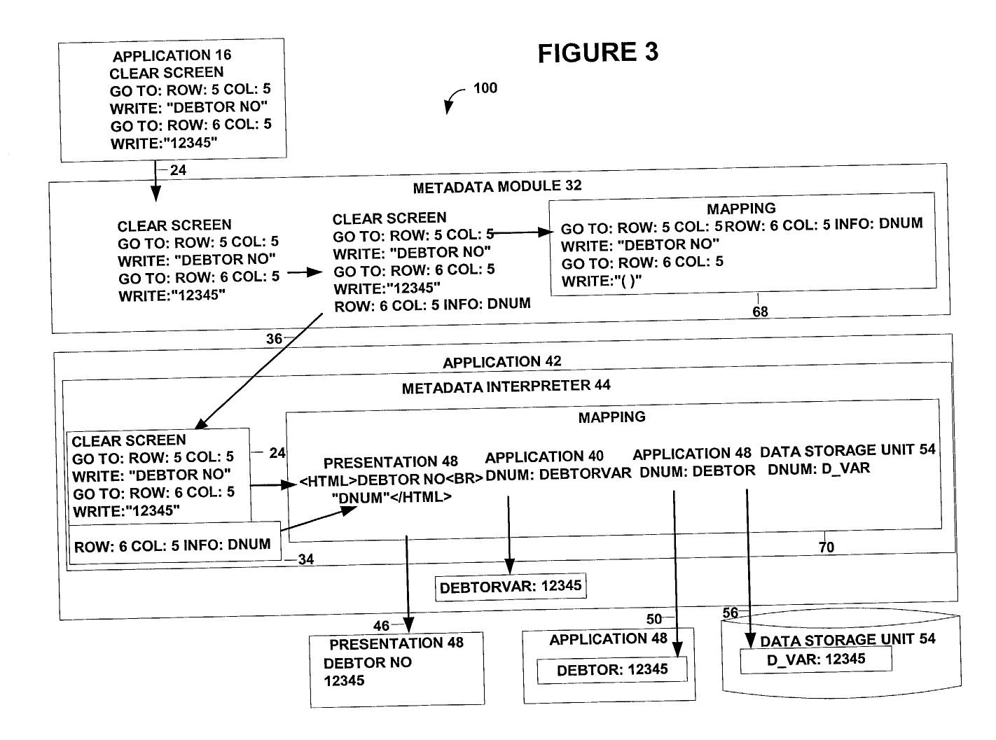

FIG. 3 demonstrates an example of data flow in the system 100. As in the other examples provided herein, it should expressly be understood that the specific data, variables, metadata, and other datastream elements used in this example are in no way intended to limit the invention. Rather, this example is given to present the principles of the invention as to how the metadata 34 can be used to extract elements of the datastream 24 for processing by another application or data storage unit, rather than merely using such datastream to generate a presentation as done in previous systems. As shown in FIG. 3, the application 16 generates a presentation datastream 24 including the sequence of instructions and data elements:

CLEAR SCREEN

GO TO: ROW: 5 COL: 5

WRITE: “DEBTOR NO”

GO TO: ROW: 6 COL: 5

WRITE: “12345”

The application 16 provides the datastream 24 to the metadata module 32 that refers to a mapping 68 stored therein to determine the metadata 34 for the received datastream 24. An element or group of elements in the datastream 24 can be used to determine corresponding metadata 34. For example, the series of datastream elements:

CLEAR SCREEN

GO TO: ROW: 5 COL: 5

WRITE: “DEBTOR NO”

GO TO: ROW: 6 COL: 5

WRITE: “12345”

can be mapped by the metadata interpreter 44 to the metadata 34:

ROW: 6 COL: 5 INFO: DNUM

using the mapping 68. The metadata module 32 combines the metadata 34 with corresponding elements of the datastream 24 and supplies the resulting datastream 36 to the metadata interpreter 44 of the application 42. The metadata interpreter 44 uses the metadata 34 with a mapping 70 stored therein to map instructions or data in the datastream 36 to corresponding instructions or variables used by the computing device 28 to render the presentation 48, the application 42, the application 54, and/or the data storage unit 58. More specifically, the metadata interpreter 44 can use the elements of datastream 24 included in the received datastream 36 to retrieve presentation code that in this example written in HTML, i.e., <HTML>DEBTOR NO<BR>“DNUM”</HTML>. The metadata interpreter 44 replaces the metadata variable DNUM in this code with its corresponding data “12345” and supplies the resulting datastream 46 to the computing device 28 to render the presentation 48. The resulting HTML code can be executed by the computing device 28 to generate the presentation 26 to include the word “DEBTOR NO” followed by data “12345” immediately below. Moreover, the metadata interpreter 44 can use the mapping 70 to determine that the metadata DNUM corresponds to DEBTORVAR in the context of application 42. The metadata interpreter 44 then associates the data at screen position ROW: 6 COL: 5, i.e., “12345”, to the variable DEBTORVAR. Hence, DEBTORVAR: 12345 is supplied by the metadata interpreter 44 to the application 42. The application 42 can now process this data upon execution. Moreover, the metadata interpreter 44 can map the data “12345” to a corresponding variable of the application 54. Referring to the mapping 70, the metadata interpreter 44 determines that the metadata DNUM corresponds to the variable DEBTOR in the context of application 54. Therefore, the metadata interpreter 44 associates the variable name DEBTOR with the data “12345” and supplies the resulting datastream 50 to the application 54. Because the data is thus associated with a corresponding variable of the application 54, the application 54 can process such data upon execution. Furthermore, the metadata interpreter 44 can map the data “12345” to a name variable used by the data storage unit 58. More specifically, the metadata interpreter 44 uses the metadata DNUM to determine the variable name D_VAR that is used by the data storage unit 58. The metadata interpreter 44 supplies this variable D_VAR along with its corresponding data “12345” to the data storage unit 58. The data storage unit 58 stores such data in correspondence with the data variable D_VAR. To summarize, the metadata 34 associated with the datastream 24 permits the metadata interpreter 44 to map the elements of the datastream into the instructions or variables used by the presentation 26, applications 40, 48, or data storage unit 58. Hence, the presentation datastream 24 can be expanded to uses well beyond merely rendering a presentation, a major advantage over previous technologies.

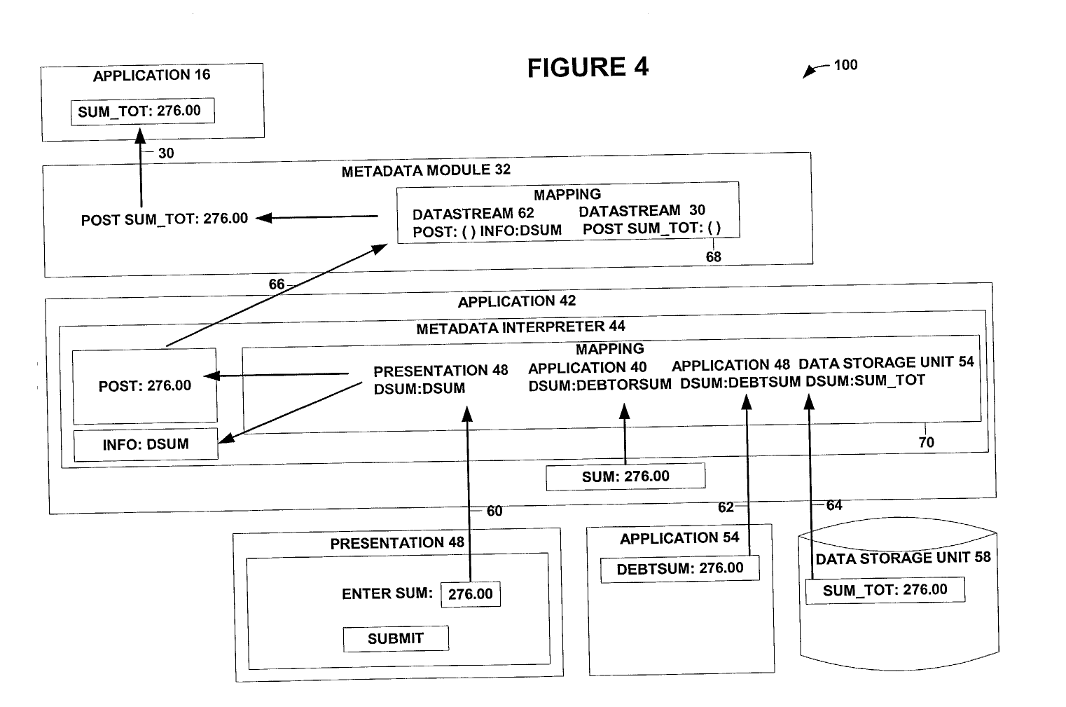

FIG. 4 demonstrates an example of data flow in the reverse sense from that of FIG. 3. The specific data, variables, metadata, and other datastream elements used in this example are intended to provide a more concrete understanding of how the invention can be implemented and used. They are not intended to limit the scope of the invention. As shown in FIG. 4, the data “276.00” is to be sent from the presentation 26, applications 40, 48 or data storage unit 58, to the application 16 using metadata 34. For example, the presentation 26 can be an HTML or XML form in which a user operates the computing device 28 to input data into an entry field of such form. This field is associated with the variable DSUM in the HTML or XML script of the web page form. The user enters the data, “276.00” in this example, into the HTML form and posts this data to the metadata interpreter 44 using the “Submit” software button. The metadata interpreter 44 receives the data “276.00” associated with the variable DSUM, and because this variable is the same as the metadata 34, the metadata interpreter 44 maps the variable to the same metadata variable DSUM. Hence, the metadata interpreter 44 associates the metadata INFO:DSUM with the POST:276.00 method. The metadata interpreter 44 generates datastream 66 including such method and data elements, and transmits such datastream to the metadata module 32. Similarly, the metadata interpreter 44 can use the mapping 70 to map the variable SUM to the metadata variable DSUM. As a result, the metadata interpreter 44 associates the data “276.00” with the metadata variable DSUM. Furthermore, the metadata interpreter 44 can use the mapping 70 to associate the variable DEBTSUM used by application 54, to the metadata variable DSUM. Likewise, the metadata interpreter 44 can associate variable name SUM_TOT used by the data storage unit 58, with the metadata DSUM. In this example, whether the variable originates from the presentation 48, the applications 40, 48, or the data storage unit 58, the metadata interpreter 44 generates the metadata 34 INFO:DSUM and associates this metadata with the instructions and data, POST:276.00. The application 42 generates the datastream 66 including the method and data POST:276.00 and the metadata INFO:DSUM and transmits this datastream 66 to the metadata module 32. The metadata module 32 uses its mapping 68 to map the datastream 66 into a context usable by the application 16. In this example, the metadata module 32 uses the mapping 70 to translate the datastream 66, POST:276.00 INFO:DSUM, into the datastream 30, POST SUM_TOT:276.00. The metadata module 32 supplies the datastream 30 to the application 16 which accepts the data SUM_TOT:276.00. Because the data “276.00” is associated with the corresponding variable SUM_TOT used by the application 16, such application can use the data “276.00” upon execution.

### General Methods Executed by Metadata Module and Metadata Interpreter

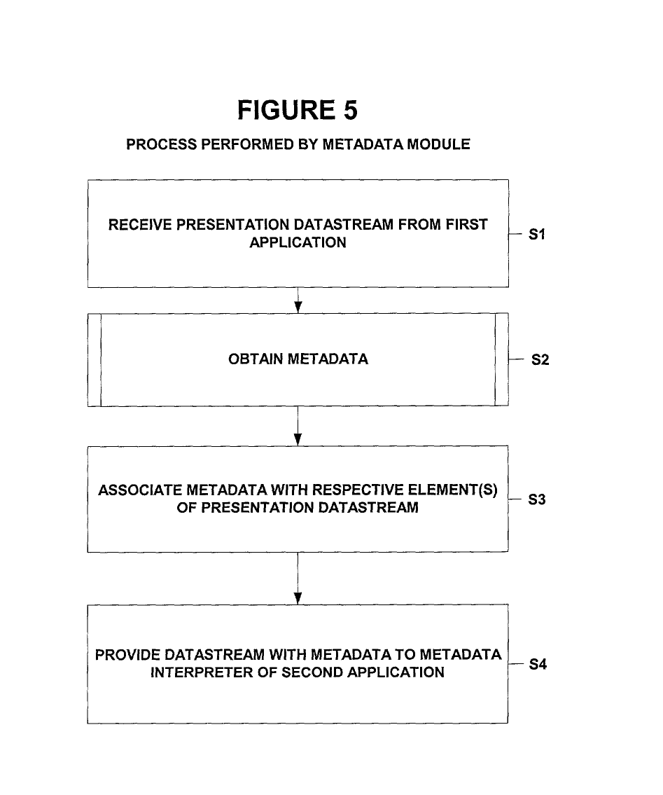

FIG. 5 is a method performed by the metadata module 32 of FIG. 2 to associate metadata 34 with elements of the datastream 24. In step S1 the metadata module 32 receives the presentation datastream 24 generated by a first application. In step S2 the metadata module 32 obtains the metadata 34 corresponding to elements of the datastream 24. In step S3 the metadata module 32 associates the metadata 34 with corresponding elements of the datastream 24 to produce the datastream 36 with metadata 34. In step S4 the metadata module 32 provides the datastream 36 with metadata 34 to the metadata interpreter 44 of the application 42.

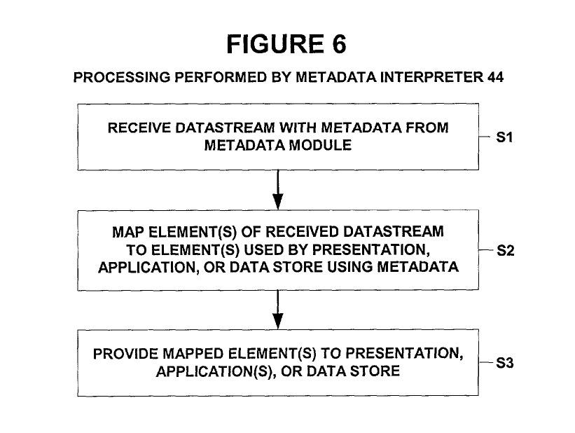

The method of FIG. 6 is an example of the manner in which processing can be performed by the metadata interpreter 44 to transform elements of datastream 36 into a form usable by the applications 42, 54, the presentation 48, and/or the data storage unit 58. In step S1 the metadata interpreter 44 receives the datastream 36 with metadata 34 from the metadata module 42. In step S2 the metadata interpreter 44 maps the element(s) of the datastream 38 to corresponding element(s) used by the computing device 28 to generate the presentation 48, the applications 42, 54, and/or the data storage unit 58. In step S3 the metadata interpreter 44 provides mapped element(s) to the target application or device. More specifically, the metadata interpreter 44 can provide the mapped element(s) in datastream 46 to the computing device 28 to render the presentation 48. Alternatively, or in addition, the metadata interpreter 44 can supply the mapped element(s) to corresponding variable(s) of the application 42 for execution in the computing environment 14 or 16. As another possibility, the metadata interpreter 44 can provide the mapped element(s) in datastream 50 to corresponding variables of the application 54 for execution on the computing device 52. Furthermore, the mapped element(s) can be provided from the metadata interpreter 44 to the data storage unit 58 in the datastream 56 for storage as data 59.

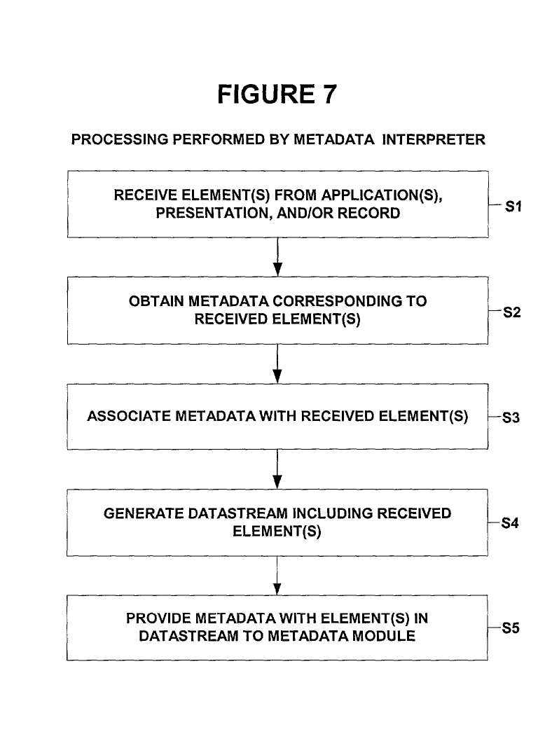

FIG. 7 is a flowchart of a method of processing performed by the metadata interpreter 44 for a datastream flowing in the reverse sense to the methods of FIGS. 5 and 6. In step S1 the metadata interpreter 44 receives element(s) from the applications 42, 54, the user interface provided by presentation 48, and/or data 59 from data storage unit 58. In step S2 the metadata interpreter 44 obtains the metadata 34 corresponding to the received element(s). In step S3 the metadata module 44 associates metadata 34 with the received element(s). In step S4 the metadata interpreter 44 generates a datastream 66 including the received element(s) and associated metadata 34. In step S5 the metadata interpreter 44 provides the datastream 66 including the received element(s) to the metadata module 32.

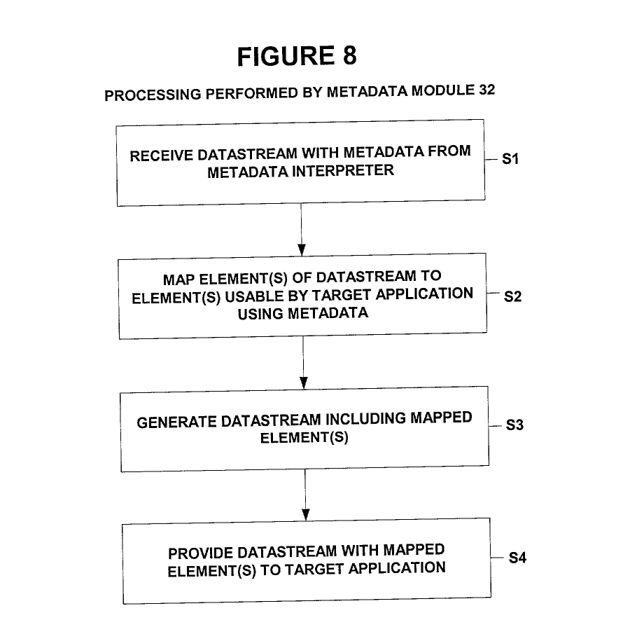

FIG. 8 is a flowchart of a method of processing performed by the metadata module 32 for a datastream traveling in the reverse sense to the methods of FIGS. 5 and 6. In step S1 the metadata module 32 receives the datastream 36 with metadata 34 from the metadata interpreter 44. In step S2 the metadata module 32 uses the metadata 34 to map the element(s) of the datastream 66 to element(s) usable by the target application 16. In step S3 the metadata module generates a datastream 30 including the mapped element(s). In step S4 the metadata module 32 provides the datastream with mapped element(s) to the target application 16.

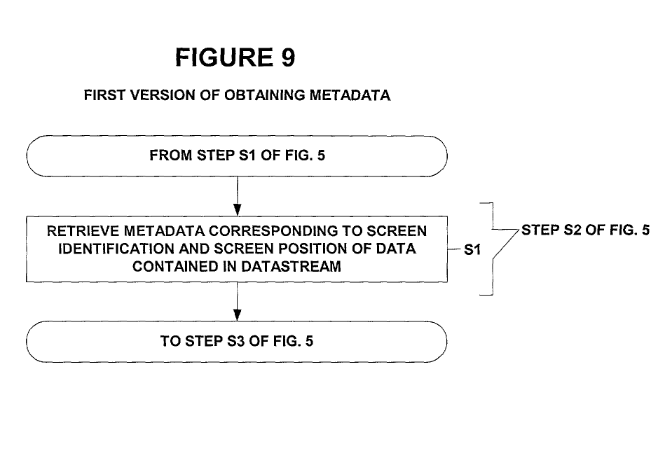

FIG. 9 illustrates one way in which step S2 of FIG. 5 can be performed by the metadata module 32 to obtain metadata 32. Starting from step S1 of FIG. 5, in step S1 of FIG. 9, the metadata module 32 retrieves the metadata 34 corresponding to the screen identification and screen position of data contained in the datastream 24. From step S1 of FIG. 9, processing returns to step S3 of FIG. 5.

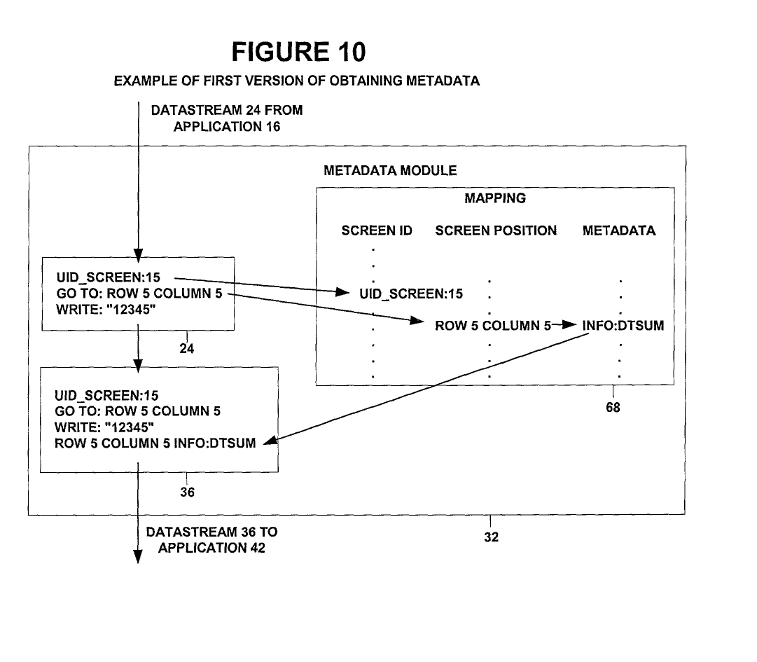

FIG. 10 demonstrates data flow in connection with the method of FIGS. 5 and 9. The metadata module 32 receives the datastream 24 including the instructions and data UID_SCREEN: 15 GO TO: ROW 5 COLUMN 5 WRITE: “12345”. The metadata module 32 uses the screen definition UID_SCREEN: 15 to locate the screen position data and metadata pertaining to Presentation Screen No. 15, which may be one of many used in the system 100, each associated with its own metadata 34. The metadata module 32 uses the screen position ROW 5 COLUMN 5 to refer to the mapping 68. The metadata module retrieves the corresponding metadata INFO:SUM and appends this to the instructions and data contained in datastream 24. The metadata module 32 supplies the datastream 36 including the instructions and data GO TO: ROW 5 COLUMN 5 WRITE: “12345” and the metadata INFO: DSUM to the metadata interpreter 44 of the application 42.

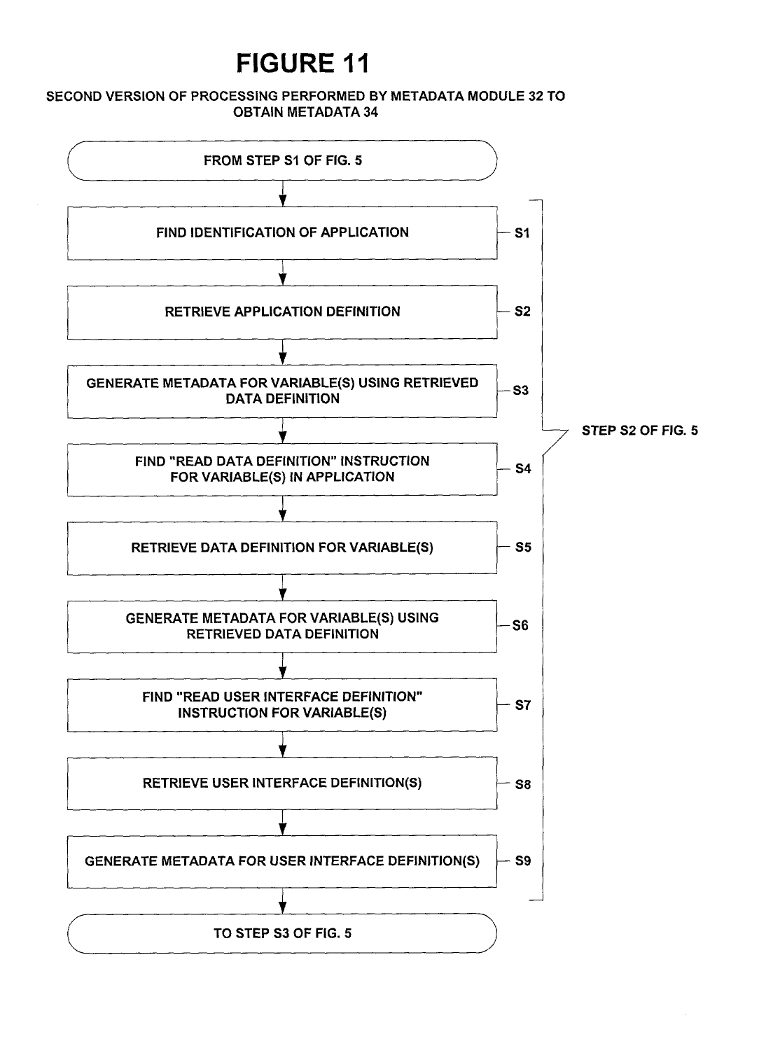

FIG. 11 is a flowchart of another method of processing performed by the metadata module 32 to obtain metadata 34. This method can be performed by a computing device or by a human. In step S1 the metadata module 32 scans the application 16 to find the identification of such application in the code thereof. In step S2 the metadata module 32 uses this identification to retrieve the corresponding application definition 40 for this particular application 16. In step S3 the metadata module 32 generates metadata 34 using the retrieved application definition 40. In step S4 the metadata module 32 finds the “read data definition” instructions in the application 16 by scanning its code. In step S5 the metadata module 32 retrieves the data definition 18 corresponding to such instruction(s). In step S6 the metadata module 32 generates metadata 34 for corresponding variables and data in the application code using the retrieved data definition 18. In Step S7 the metadata module 32 finds the “read user interface definition” instruction for corresponding variables(s) and data in the application code. In step S8 the metadata module 32 retrieves the user interface definition(s) 20 for the corresponding variable(s) and data in the application code. In step S9 the metadata module 32 generates metadata 34 for the user interface definitions 20. After performance of Step S9 of FIG. 11, processing returns to step S3 of FIG. 5.

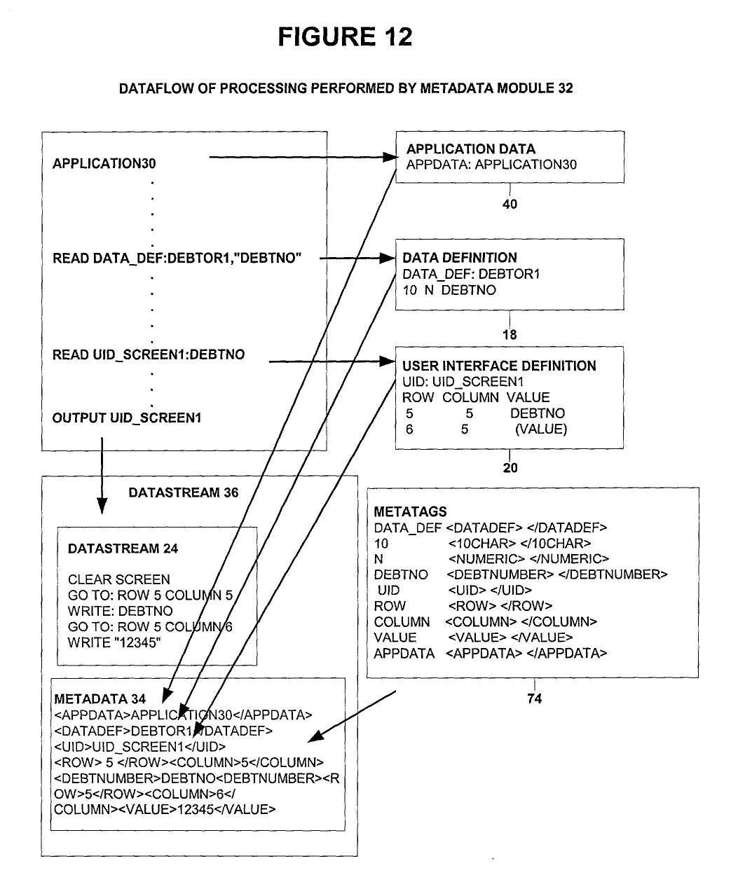

FIG. 12 shows an example of data flow for the method of FIG. 11. This method can be performed by a human or by the metadata module 32 executed in a computing environment to perform the following functions. The first step is to identify an application 16, termed “Application30” in this example, and retrieve its corresponding application definition 40. This application 16 is scanned to find a read command instruction requesting retrieval of a data definition 18 for a variable. In this example, the variable is DEBTNO and its corresponding data definition is read from memory. The application 16 is scanned to find a read command requesting retrieval of a user interface definition 20 corresponding to the variable DEBTNO. This user interface definition 20 indicates that the characters “DEBTNO” are to appear at character screen position row 5, column 5, followed by the value generated by the application 16 in correspondence with the variable DEBTNO. The application definition 40, the data definition 18, the user interface definition 20, and the metatags 74, are used to generate metadata 34. More specifically, the metadata 34 are generated to include tagged elements identifying the application, <appdata>application 30</appdata>, the data definition, <datadef>debtor1</datadef>, and the user interface definition, <uid>uid_screen1</uid>. The metadata 34 also comprises the tagged sequence:

<ROW>5</ROW><COLUMN>5</COLUMN>
<DEBTNUMBER>DEBTNO<DEBTNUMBER>
<ROW>5</ROW><COLUMN>6<COLUMN>
<VALUE>12345</VALUE>

that permits the metadata interpreter 44 to determine the screen position and data for transforming the datastream 36 into a form usable by the computing device 28 to render the presentation 48, the computing environments 14, 16 to execute applications 42, 54, and/or the data storage unit 58 to store, modify, or retrieve data 59.

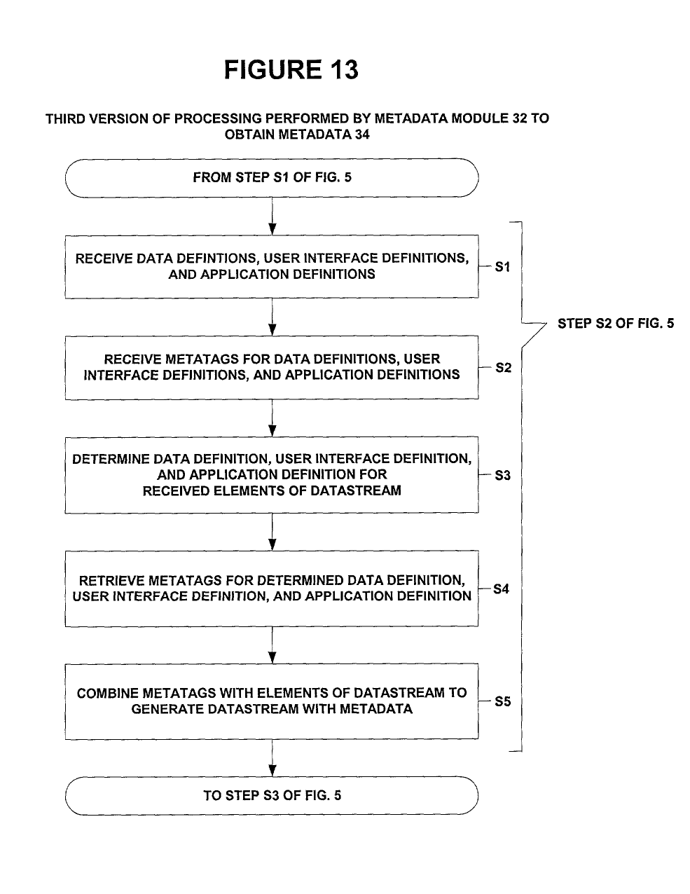

FIG. 13 is yet another method performed by the metadata module 32 to generate the datastream 36. In this example, the datastream 36 includes the elements of datastream 24 as well as associated metadata 34. In step S1 the method of FIG. 13 comprises receiving data definitions 18, user interface definitions 20, and application definitions 40. In step S2 the metadata module 32 receives metatags for the data definitions 18, user interface definitions 20, and application definitions 40. In step S3 the metadata module 32 determines the data definition 18, the user interface definition 20, and the application definition 40 that correspond to the element(s) of the datastream 24. In step S4 the metadata module 42 retrieves metatags corresponding to the determined data definition 18, user interface definition 20, and application definition 40. In step S5 the metadata module 32 combines the metatags 74 with corresponding elements of the datastream 24 to generate the datastream 36 including metadata 34. After processing of step S5 of FIG. 13, processing returns to step S3 of FIG. 5.

### Relatively Specific Examples of Data Flow in the Invented System

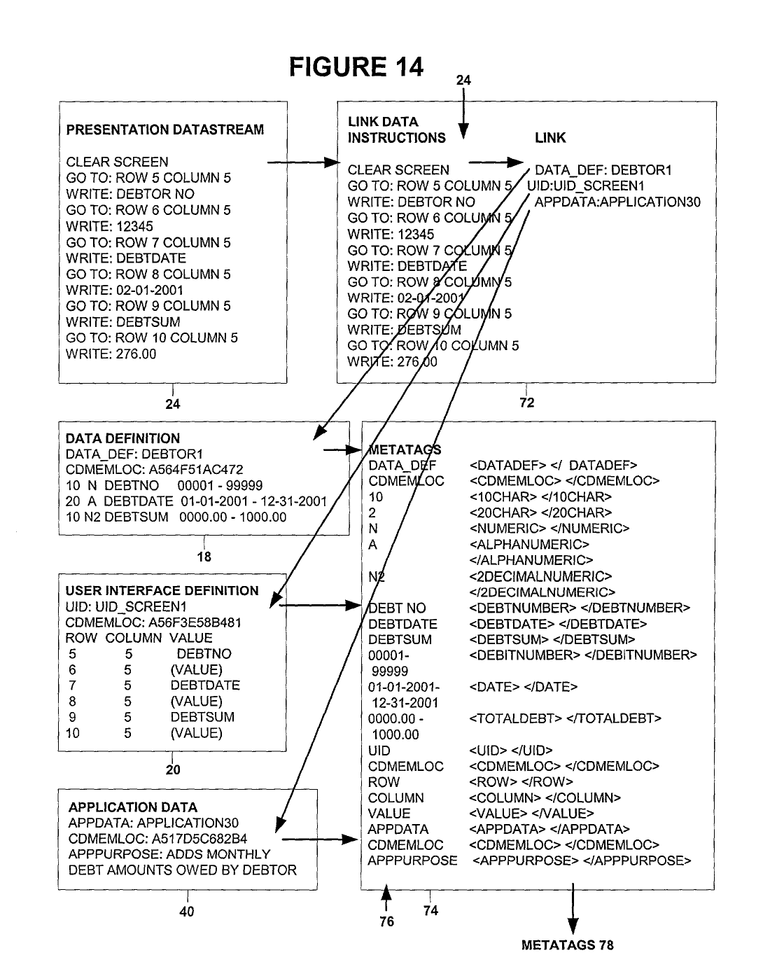

FIG. 14 is an example of data flow corresponding to the method of FIG. 13. The data flow of FIG. 14 is performed by the metadata module 32 which in this example is provided with link data 72 and metatags 74 in addition to the data definition 18, the user interface definition 20, and the application definition 40. The metadata module 42 uses the presentation datastream 26 to refer to the link data 72 that identifies the data definition 20, user interface definition 20, and application 42. It should be appreciated that in a typical situation, there may be numerous data definitions 18, user interface definitions 20, and application definition 40 for the different data, presentation screens, and applications that may be supported by the system 100. By using unique instructions or series of instructions in the datastream 24, the link data 72 can be used to determine the corresponding data definition 18, user interface definition 20, and application definition 40 for such datastream. In this example, the datastream 24 corresponds to the data definition DATA_DEF:DEBTOR1, the user interface definition UID:UID_SCREEN1, and the application definition APPDATA:APPLICATION30. The metadata module 42 uses the variables DEBTORI, UID_SCREEN1, and APPLICATION30, to identify the corresponding data definition, user interface definition, and application definition. As shown in FIG. 9, in this example, the data definition is:

DATA_DEF: DEBTOR1

CDMEMLOC: A564F51AC472

10 N DEBTNO 00001-99999

A DEBTDATE 01-01-2001-12-31-2001

10 N2 DEBTSUM 0000.00-1000.00

in which DATA_DEF is the data definition variable used by the metadata module 42, DEBTOR1 identifies this specific data definition, CDMEMLOC is a variable corresponding to A564F51AC472 that indicates in hexadecimal notation the memory location of the data definition in the computing environment executing the metadata module 42. The line “10 N DEBTNO 00001-99999” is a data definition that defines the variable DEBTNO to be associated with numeric data of ten (10) characters or less, that is a positive integer N, in a range from 00001 to 99999. The line “20 A DEBTDATE 01-01-2001-12-31-2001” is a data definition that defines the variable DEBTDATE to be a twenty (20) character alpha-numeric data in a range from 01-01-2001 to 12-31-2001. Similarly, the data definition “10 N2 DEBTSUM 0000.00-1000.00” means that the variable DEBTSUM is associated with data that is a number as many as ten (10) characters long with two decimal places N2, and a range from 0000.00-1000.00.

In the example of FIG. 14, the user interface definition 20 stores the identification variable DATA_DEF identifying DEBTOR1 as the specific definition of this example. The user interface definition 20 of this example is listed as follows:

UID: UID_SCREEN1

CDMEMLOC: A56F3E58B481

| ROW | COLUMN | VALUE |
|---|---|---|
| 5 | 5 | DEBTNO |
| 6 | 5 | (VALUE) |
| 7 | 5 | DEBTDATE |
| 8 | 5 | (VALUE) |
| 9 | 5 | DEBTSUM |
| 10 | 5 | (VALUE) |

The user interface definition 20 includes data identifying the memory location variable CDMEMLOC as A56F3E58B481, a hexadecimal number identifying the location of this specific user interface definition in the computing environment 12. The following data table indicates the ROW, COLUMN, and VALUE, indicating the character screen position and data as they are to be rendered in the presentation for the screen identified as UID_SCREEN1. For example, at row 5, column 5, the value DEBTNO is displayed on the screen, followed by the value (VALUE) associated with DEBTNO at row 5, column 6. At the screen position for row 5, column 7, the value DEBTDATE is to be displayed on the screen, followed by the value (VALUE) at row 8, column 5. Lastly, in this example, the user interface definition UID_SCREEN1 indicates that the variable DEBTSUM at row 9, column 5, is associated with the value (VALUE) at row 10, column 5 on the screen.

In FIG. 14, the application definition 40 stores information regarding the application. The application definition 40 of this example is listed as follows:

APPDATA: APPLICATION30

CDMEMLOC: A517D5C682B4

APPPURPOSE: ADDS MONTHLY DEBT AMOUNTS OWED BY DEBTOR

In this example, the application definition 40 includes the variable APPDATA that is associated with the value APPLICATION30, this identifying the application to distinguish from others that may be hosted by the computing environment 12. The application definition 40 includes the variable CDMEMLOC associated with the hexadecimal value A517D5C682B4. This is the memory location of the application 16 in the computing environment 12. The application definition 40 can comprise also comprise data that describes the purpose of the application 16. Thus, in this example, the variable APPPURPOSE is associated with the statement “ADDS MONTHLY DEBT AMOUNTS OWED BY DEBTOR.”

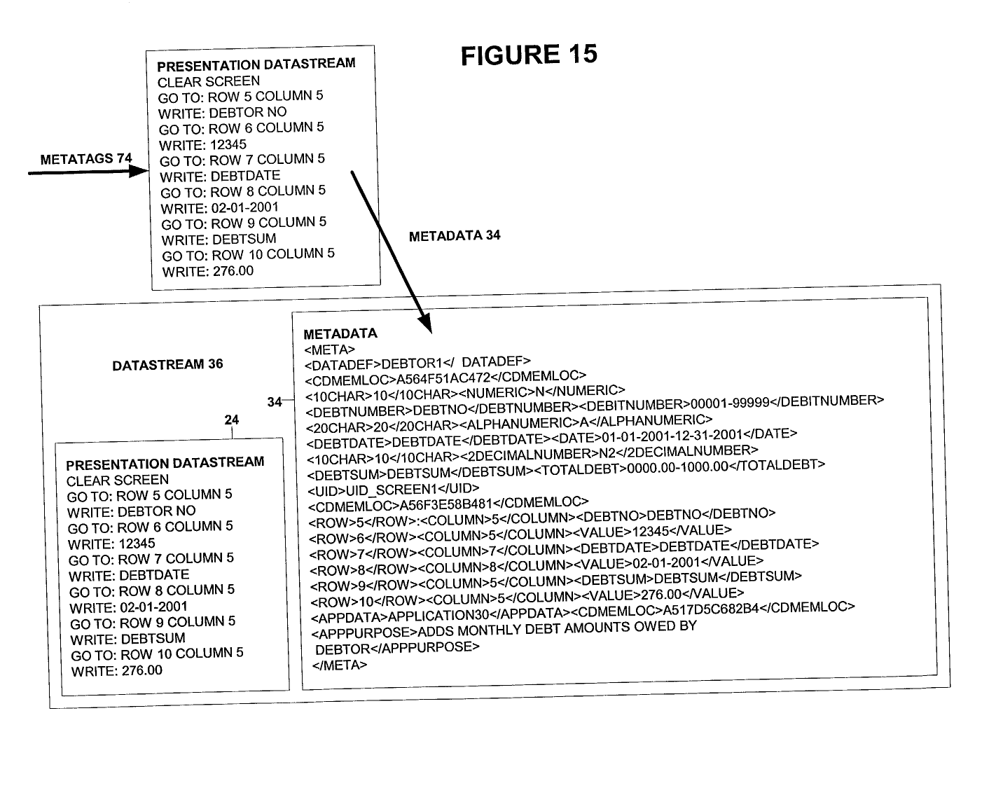

The metadata module 42 can associate any or all of the elements in the data definition 18, the user interface definition 20, and the application definition 40, with metatags 78 contained in the mapping 74. The mapping 74 lists the elements of the data definition 18, the user interface definition 20, and the application definition 40, in correspondence with the metatags 78. The metadata module 42 uses the mapping 74 to determine the metatags 78 to be applied to each element of the data definition 18, the user interface definition 20, and the application definition 40. As shown in FIG. 15, the metadata module 42 associates the metatags 78 with corresponding elements of the data definition 18, user interface definition 20, and the application definition 40. The resulting metadata 34 is supplied along with the elements of the presentation datastream 24, in the datastream 36 to the application 42. The application 42 has all metadata 34 required to interpret the datastream 36.

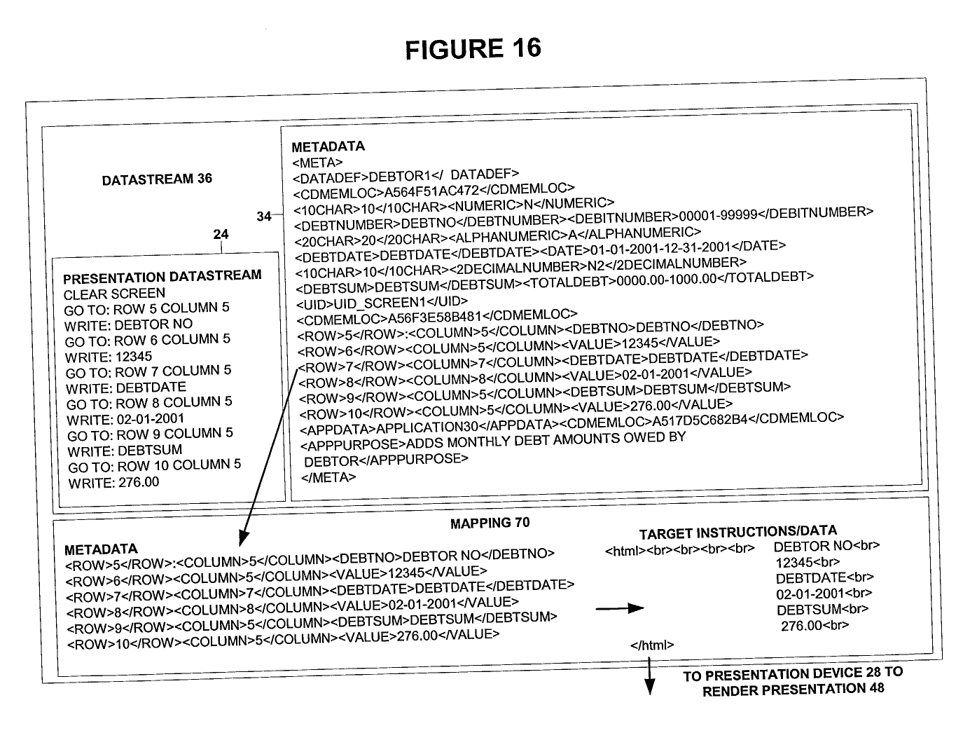

FIG. 16 shows an example of data flow corresponding to a portion of the method of FIG. 13. This data flow can occur within the metadata interpreter 44. In the example of FIG. 15, the datastream 36 with metadata 34 is received by the metadata interpreter 44 that uses this metadata to determine corresponding computer instructions or variables in the respective contexts of the computing device 28 rendering the presentation 48, the applications 40, 54 executed on computing environments 14, 16, or the data storage unit 58 storing the data 59. More specifically, the metadata interpreter 44 can use the mapping 70 to generate HTML code for the presentation 48, <html><br><br><br><br><br>_{—}_{—}_{—}_{—} 12345</html>, and provides this code in the datastream 46 to the computing device 28 that renders such presentation. In effect, this HTML code displays the data “12345” at row 5, column 5, of the presentation 48. Thus, the presentation 48 rendered by the computing device 28 is equivalent to that of the datastream 24 generated by the application 16, although the code is not the same, one being expressed in RPG and the other in HTML. Moreover, the metadata module 44 can use the mapping 70 to map the metadata INFO:DSUM to a variable DBTTOT used in the context of application 42 for the corresponding data “12345”. Hence, the metadata interpreter 44 provides the variable DBTOT and corresponding data “12345” to the application 42. The application 42 can process such data because it is mapped to a variable used by such application. Furthermore, the metadata interpreter 44 can use the mapping 70 to map the data “12345” corresponding to metadata 34, to the name variable DEBTOR T. The metadata interpreter 44 provides the data “12345” with the corresponding name variable DEBTOR_T. Because the name variable DEBTOR_T is used by the data storage unit 58, it is able to store the data “12345” in correspondence with variable name DEBTOR T as data 59 stored in the data storage unit 58.

FIG. 16 indicates data flow in the metadata interpreter 44 to render target instructions and data for rendering the presentation 48. More specifically, the metadata interpreter 44 extracts from the metadata 34 the following code sequence:

<ROW>5</ROW>:<COLUMN>5</COLUMN><DEBTNO>DEBTNO</
DEBTNO>
<ROW>6</ROW><COLUMN>5</COLUMN><VALUE>12345</
VALUE>
<ROW>7</ROW><COLUMN>7</COLUMN><DEBTDATE>
DEBTDATE</DEBTDATE>
<ROW>8</ROW><COLUMN>8</COLUMN><VALUE>02-01-2001</
VALUE>
<ROW>9</ROW><COLUMN>5</COLUMN><DEBTSUM>
DEBTSUM</DEBTSUM>
<ROW>10</ROW><COLUMN>5</COLUMN><VALUE>276.00</
VALUE>.

Thus, in this example, the metadata interpreter 44 does not use all of the metadata 34. The metadata interpreter 44 has access to a mapping 70 that maps the sequence of metadata 34 to corresponding target instructions and/or data for rendering the presentation 48. In this example, the target instructions and data are coded in HTML, as follows:

<html>
<br>
<br>
<br>
<br> _{— — — —} DEBTOR NO<br>
_{— — — —} 12345<br>
_{— — — —} DEBTDATE<br>
_{— — — —} 02-01-2001<br>
_{— — — —} DEBTSUM<br>
_{— — — —} 276.00<br>
</html>

in which “_” indicates space characters. This HTML code can be executed by a computing environment using a browser application, and will render a presentation 48 with the data at screen positions equivalent to that that would have been rendered by a terminal capable of executing the original datastream 24. However, it should be understood that it is within the scope of the invention that the presentation 48 rendered by the computing device 28 need not be identical in terms of screen position or what data is displayed as compared to the original datastream 24. The invention thus affords great flexibility as to what element(s) within the datastream 24 are selected for use in the target presentation, application, or data storage.

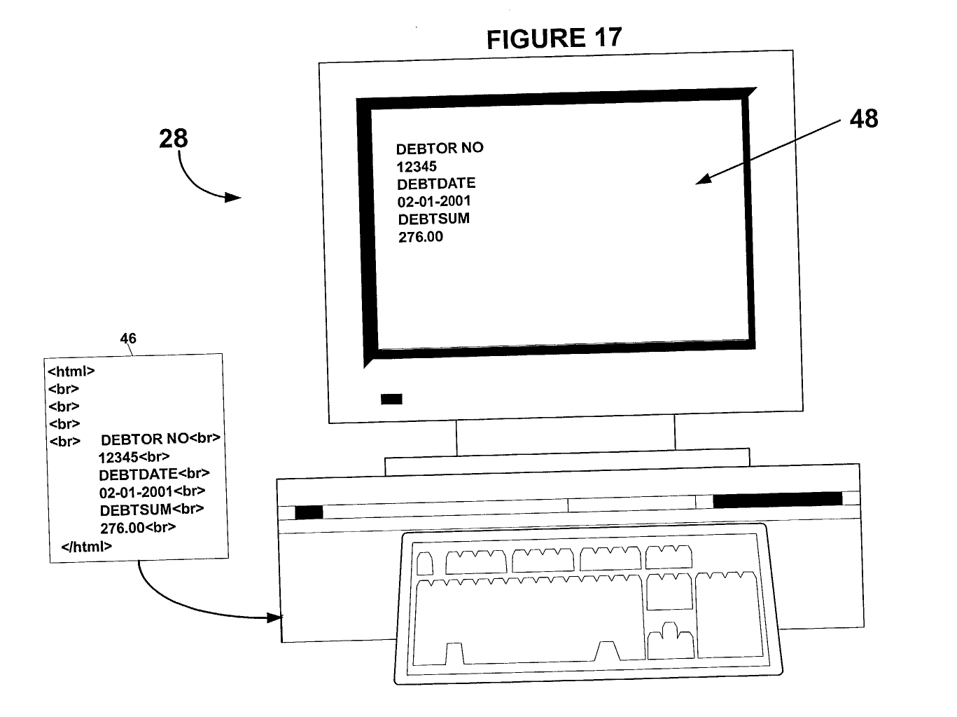

FIG. 17 is a view of the computing device 28 supplied with datastream 46 including the HTML code from the metadata interpreter 44. The computing device 28 executes a browser application that receives the HTML code of datastream 46. Execution of the HTML code by the computing device 28 renders the presentation 48 that includes the displayed characters:

DEBTOR NO

12345

DEBTDATE

02-01-2001

DEBTSUM

276.00.

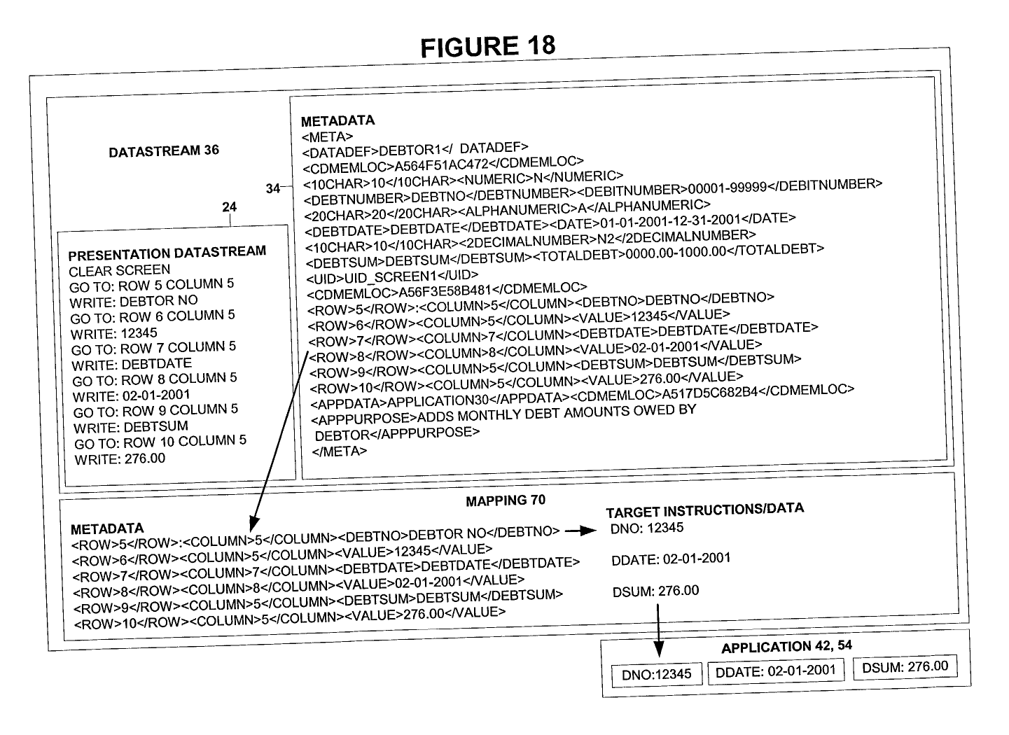

In FIG. 18, the metadata interpreter 44 uses the metadata 34 to determine target instructions and data for the application 42 or 54. More specifically, the metadata interpreter 44 uses the mapping 70 to map the metadata 34:

<ROW>5</ROW>:<COLUMN>5</COLUMN><DEBTNO>DEBTNO</
DEBTNO>
<ROW>6</ROW><COLUMN>5</COLUMN><VALUE>12345</
VALUE>

to the target instructions and data:

DNO: 12345.

Similarly, the metadata module 32 maps the metadata 34:

<ROW>7</ROW><COLUMN>7</COLUMN><DEBTDATE>
DEBTDATE</DEBTDATE>
<ROW>8</ROW><COLUMN>8</COLUMN><VALUE>02-01-2001</
VALUE>

to the target instructions and data:

DDATE: 02-01-2001.

Furthermore, the metadata module 32 maps the metadata 34:

<ROW>9</ROW><COLUMN>5</COLUMN><DEBTSUM>DEBTSUM</DEBTSUM>

<ROW>10</ROW><COLUMN>5</COLUMN><VALUE>276.00</VALUE>

to the target instructions and data:

DSUM:276.00.

The resulting target instructions and data are output to the application 42, or to the application 54 via the datastream 62. Thus, the metadata 34 can be used to map data from the variables DEBTOR NO, DEBTDATE, and DEBTSUM in the datastream 36 to respective variables DNO, DDATE, and DSUM, so that the corresponding data can be processed by the applications 42, 54.

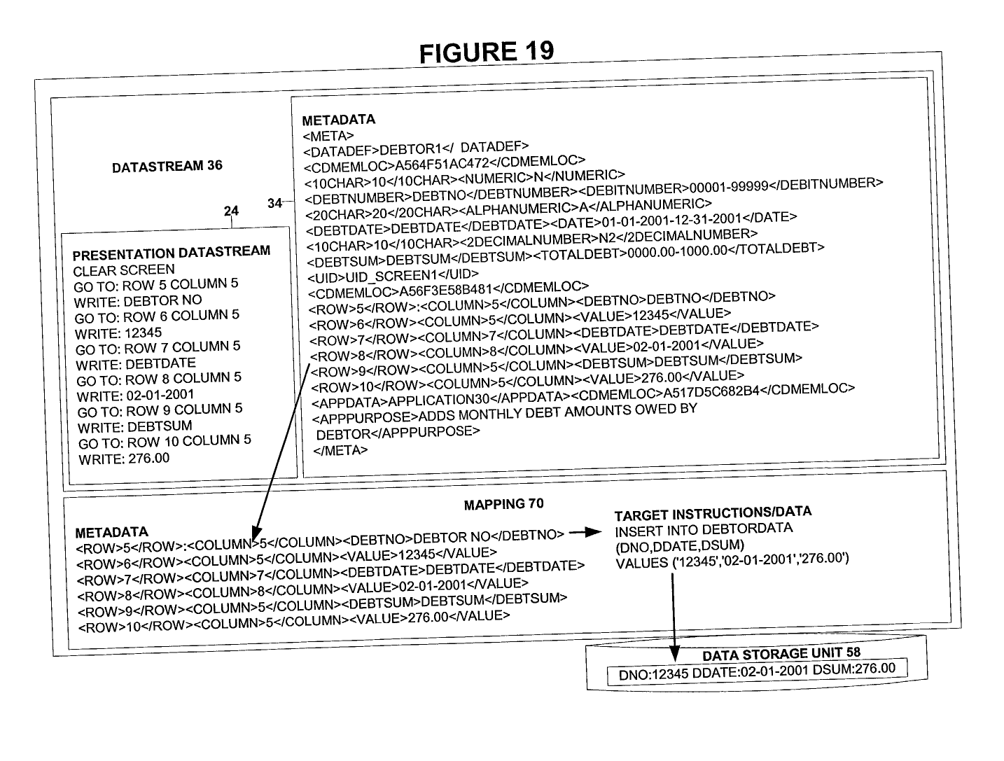

In FIG. 19, the metadata interpreter 44 uses the metadata 34 to determine Structured Query Language (SQL) instructions for storing elements of the datastream 36 as data 59 in the data storage unit 58. In this example, the metadata interpreter 44 uses the metadata 34:

<ROW>5</ROW>:<COLUMN>5</COLUMN><DEBTNO>DEBTNO</
DEBTNO>
<ROW>6</ROW><COLUMN>5</COLUMN><VALUE>12345</
VALUE>
<ROW>7</ROW><COLUMN>7</COLUMN><DEBTDATE>
DEBTDATE</DEBTDATE>
<ROW>8</ROW><COLUMN>8</COLUMN><VALUE>02-01-2001</
VALUE>
<ROW>9</ROW><COLUMN>5</COLUMN><DEBTSUM>
DEBTSUM</DEBTSUM>
<ROW>10</ROW><COLUMN>5</COLUMN><VALUE>276.00</
VALUE>

with the mapping 70 to determine the corresponding SQL instructions:

INSERT INTO DEBTORDATA

(DNO,DDATE,DSUM)

VALUES (‘12345’,‘02-01-2001’,‘276.00’).

Upon executing these instructions, the data storage unit 58 will insert data 59 containing the variables DNO, DDATE, and DSUM with corresponding values “12345”, “02-01-2001”, and “276.00” into the data storage unit 58.

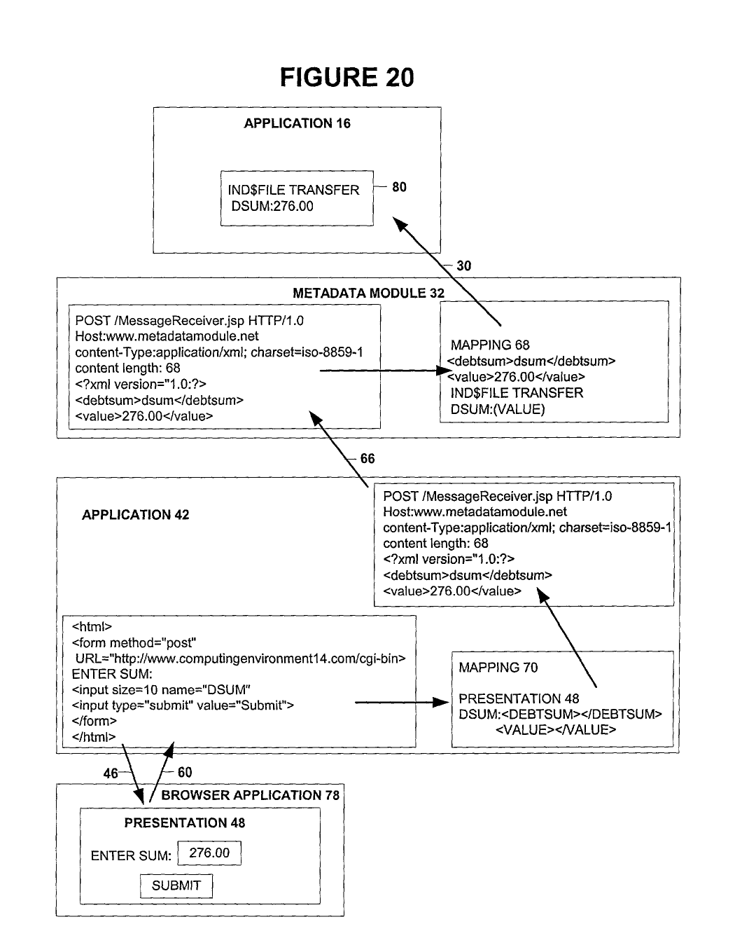

FIG. 20 is an example of an operation for using metadata to transfer data from the presentation 48 to the application 16, and in the process, transforming the data from the context of presentation 48 to the context of application 16. The application 42, optionally in response to a request from the application 16, renders the presentation 48 as an HTML form with the following code:

<html>
<form method=“post”URL=“http://www.computingenvironment14.com/cgi
-bin>
ENTER SUM:
<input size=10 name=“DSUM”
<input type=“submit” value=“Submit”>
</form>
</html>

The user operates the browser application 78 by entering data, in this example “276.00”, and posts this data in connection with the variable DSUM to the application 42 using the post method initiated by activating the software button “Submit.” The application 42 maps the variable DSUM and its corresponding value “276.00” to the appropriate metadata tags <debtsum></debtsum>and <value></value>using the mapping 70. The application 42 applies the tags to the variable and its value to produce the combined data and metadata, in this example, <debtsum>dsum</debtsum><value>276.00</value>. The application 42 then posts the data and metadata to the metadata module 32 in the datastream 66 using the post method:

POST/MessageReceiverjsp HTTP/1.0

Host:www.metadatamodule.net

content-Type:application/xml; charset=iso-8859-1

content length: 68

<?xml version=“1.0:?>

<debtsum>dsum</debtsum>

<value>276.00</value>.

The metadata module 32 receives the datastream 66 and maps the elements thereof to corresponding elements of the datastream 30. More specifically, the metadata module 32 in this example uses the metadata tags<debtsum>dsum</debtsum><value>276.00</value> to determine the appropriate data format and operation to transfer the data to the application 16. In this example, the metadata module 32 uses the IND$FILE file transfer operation to transfer in the datastream 30 a file containing the variable DSUM and its corresponding value “276.00.” The application 16 receives and processes the file and the contained data DSUM: 276.00. The application 16 is able to extract the variable DSUM and its corresponding value “276.00” because the variable DSUM is used by such application and the IND$FILE file transfer operation in the 3270 terminal protocol is in this example supported by the application 16.

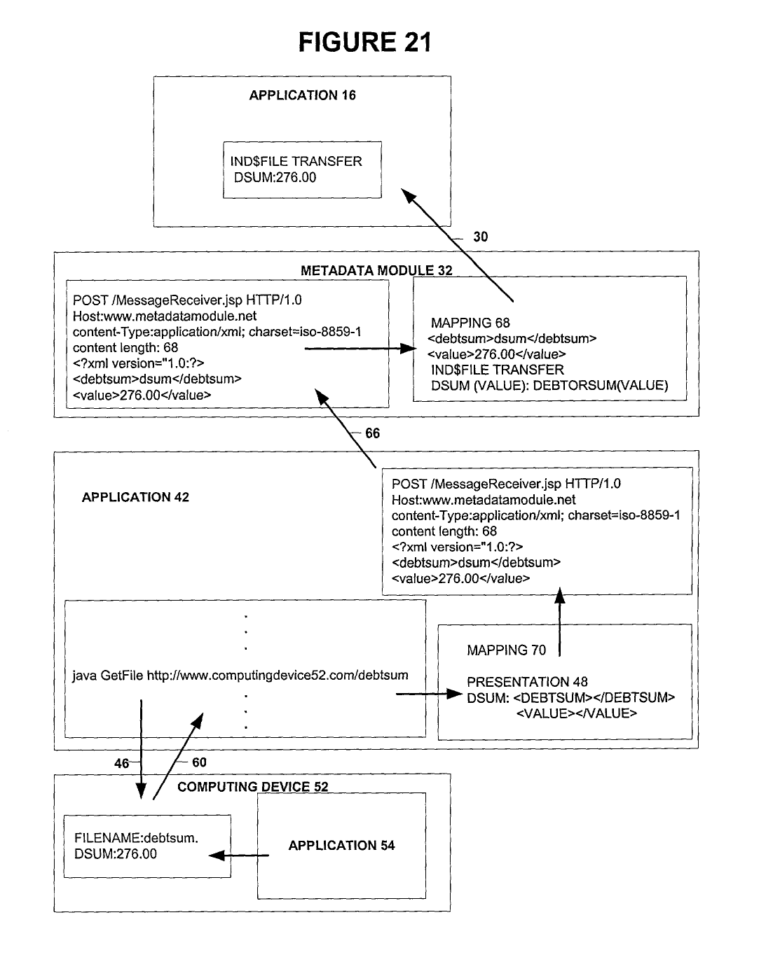

FIG. 21 is a data flow diagram in which the application 54 executed by the computing device 52 generates a data file DEBTSUM with the variable DSUM and its corresponding data “276.00.” The application 42 executes the instruction:

java GetFile http://www.computingdevice52.com/debtsum

to obtain the FILENAME:debtsum. Alternatively, application 42 could obtain the filename:debtsum by opening a socket connection to the application 54 to upload this data. The application 42 receives the filename:debtsum and uses its mapping 70 to determine the corresponding metadata tags for the data contained in the file. From this point in the data flow onward, processing proceeds as previously described with respect to the data flow of FIG. 20, the result being that the application 16 receives the data DSUM:276.00 in a form usable by the application 16.

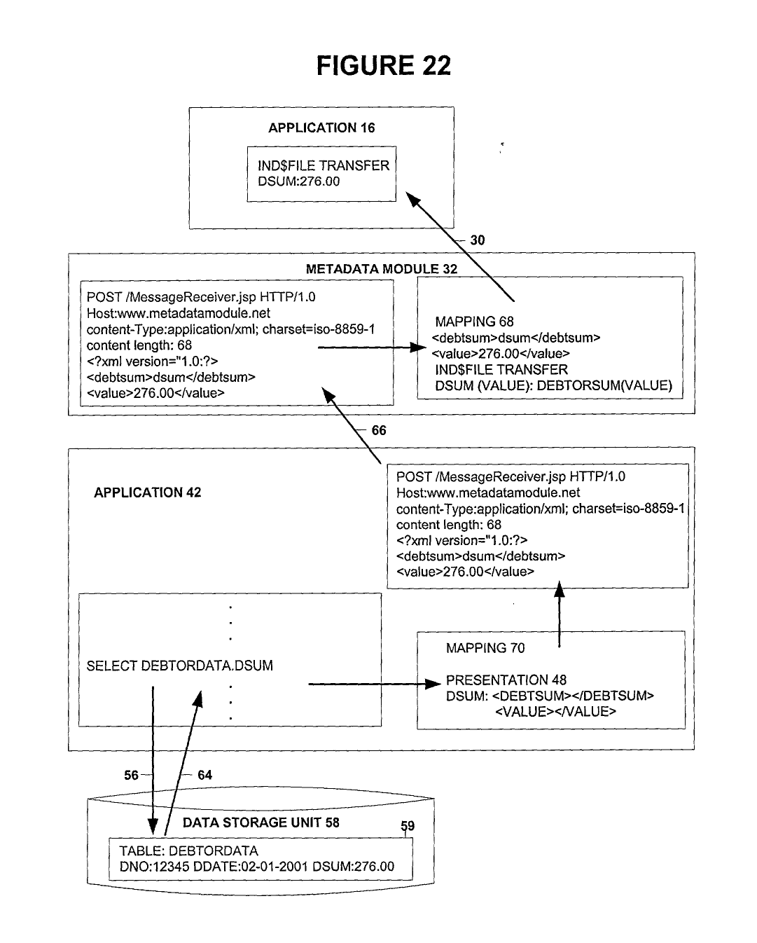

FIG. 22 is a data flow diagram in which the application 42 queries the data storage unit 58, optionally in response to a request sent from the application 16. More specifically, the application 42 executes the SQL command SELECT DEBTORDATA.DSUM to select the data for variable DSUM from the table of data DEBTORDATA containing data for DNO, DDATE, and DSUM, as shown in FIG. 22. The application 42 retrieves the data “276.00” corresponding to name variable DSUM and uses the mapping 70 to generate its corresponding metadata 34. From this point in the data flow onward, the data flow is similar to that previously described with respect to FIG. 20. The data DSUM:276.00 is thus transferred from the data storage unit 58 to the application 16 in a form usable by this application.

### Relatively Specific Embodiment of Invented System

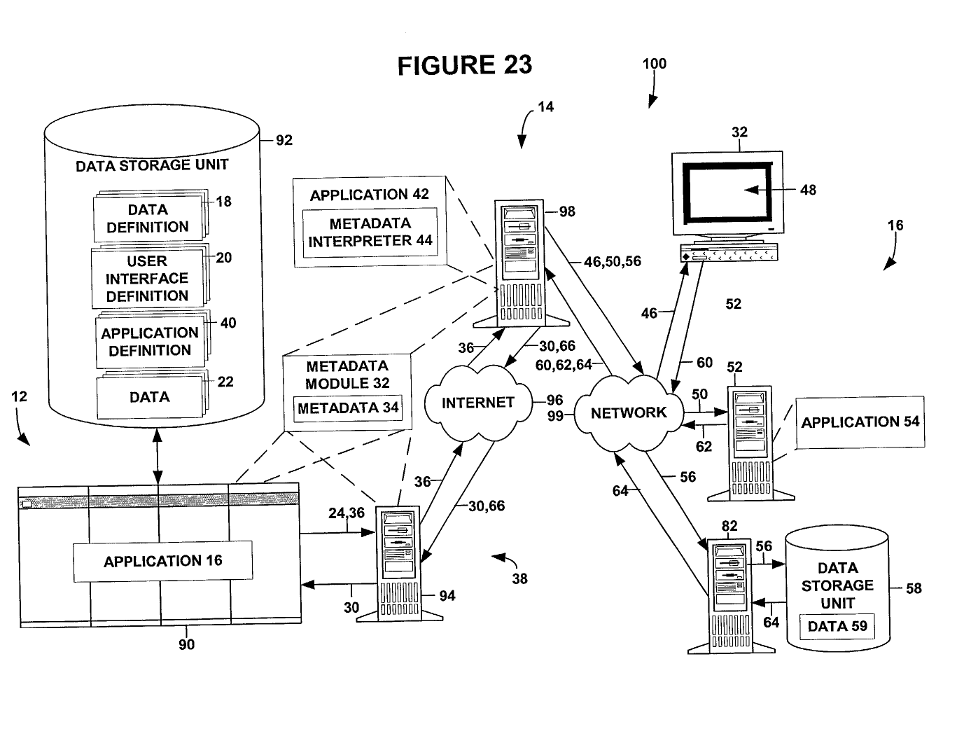

FIG. 23 is a view of a specific embodiment of the system 100. In this example, the computing environment 12 comprises host computer 90 and data storage unit 92. The host computer 90 executes the application 16 that can be programmed in RPG, CL, or COBOL, or CICS, for example. The data storage unit 92 stores the data definition 18, the user interface definition 20, the application definition 40, and the data 22. The user interface definitions 20 can be programmed in DDS or BMS, for example. The remaining definitions and data can be stored in the data storage unit 92 in one of numerous formats and protocols known to those of skill in the art. The host computer 90 generates the datastream 24 as a result of execution of the application 16 using the stored definitions 18, 20, 40, and/or the data 22. The host computer 90 can be provided with the metadata module 32, in which case the host computer generates the metadata 34 and associates it with respective elements of the data stream 24 to produce datastream 36. Alternatively, the host computer 90 can be coupled to a server 94 within its own environment 12, or a stand-alone environment 38. As yet another alternatively, the host computer 90 can be coupled to supply the datastream 24 via the Internet 96 to server 98 within environment 14. The server 98 can likewise execute the metadata module 32 to associate metadata 34 with corresponding elements of the datastream 24 to generate the datastream 36. The server 98 can execute the metadata interpreter 44 using the metadata 34 to transform the datastream 36 into a form usable by the application 42. Alternatively, or in addition, the server 98 can use the metadata 34 to transform the datastream 36 into one compatible for use with the computing device 28, the application 54, or the data storage unit 58. In this example, the server 98 provides the datastream 46 to the computing device 28 via the Internet 96 to render the presentation 48 thereon. Moreover, the server 98 can supply the datastream 50 to the computing device (server) 52 for execution by the application 54. Furthermore, the server 98 can use the metadata 34 to transform the datastream 36 into the datastream 56, and can provide this datastream via the Internet to the data server 82. The server 92 supplies the datastream 56 to the data storage unit 58.

As should now be apparent, the system 100 can be interactive or operate in the reverse sense to the process described above. More specifically, a user of the presentation 48 rendered on the computing device 28, or the application 54 executed on the computing device 52, or the data storage unit 58 using stored data 59, can generate respective datastreams 60, 62, 64. Such devices can provide these datastreams 60, 62, 64 to the server 98 via the network 99. The network 99 can be an intranet, the Internet, or other network. The server 98 executes the metadata interpreter 44 to associate metadata 34 with corresponding elements of the datastreams 60, 62, 64 to produce datastream 66. The server 98 can provide the resulting datastream 66 to the server 94 and/or host computer 90 via the Internet 96. The server 94 or host computer 90 can execute the metadata module 32 using the metadata 34 to transform the datastream 66 into the datastream 30 which is in a form usable by the application 16. Alternatively, the server 98 can execute the metadata module 32 to use the metadata 34 to transform element(s) of the datastream 66 into the datastream 30 provided to the server 94 or host computer 90 via the Internet 96. The server 94 or the host computer 90 can instead execute the metadata module 32 to transform the datastream 66 into the datastream 30 that is in a form usable by the application 16. Upon conversion, the application 16 can be executed by the host computer 90 to use the element(s) received in the datastream 30.

### Computer-Readable Media Storing the Metadata Module with Metadata and the Metadata Interpreter

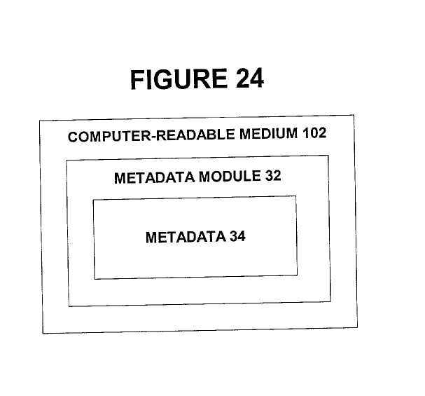

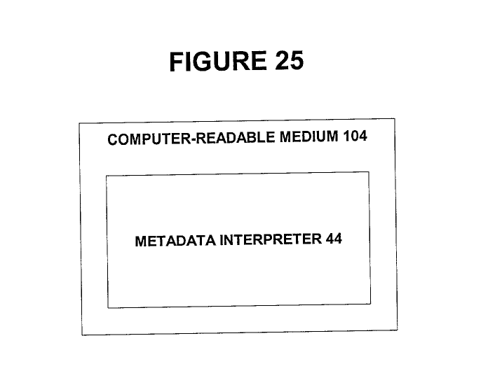

As shown in FIG. 24, it is herein expressly contemplated that the metadata module 32 can be stored in a computer-readable medium 102. For example, such computer-readable medium 102 can be used to transport the code of the metadata module 32 to a computing device or environment for loading and execution. Similarly, as shown in FIG. 25, the metadata interpreter 44 can be stored in a computer-readable medium 104. Using the computer-readable medium 104, the code of the metadata interpreter 44 can be transported to a computing device or environment for loading and execution.

### Use of Metadata for Computer Programming

It should be appreciated that although an element(s) of a datastream generally has very little or no discernible information regarding the identity of such element(s) or the resources used in its/their generation, the associated metadata 34 does contain such information. The metadata 34 can thus be useful to a programmer that desires to modify an application 16, the data definition 18, the user interface definition 20, or other resource used in the generation of such datastream. Moreover, the presence of the metadata 34 in the datastream permits the programmer to use one or more elements of the datastream in another different application, object, or module. Hence, the programmer of ordinary skill in the art will appreciate that the use of the metadata 34 significantly extends the usefulness of a datastream.

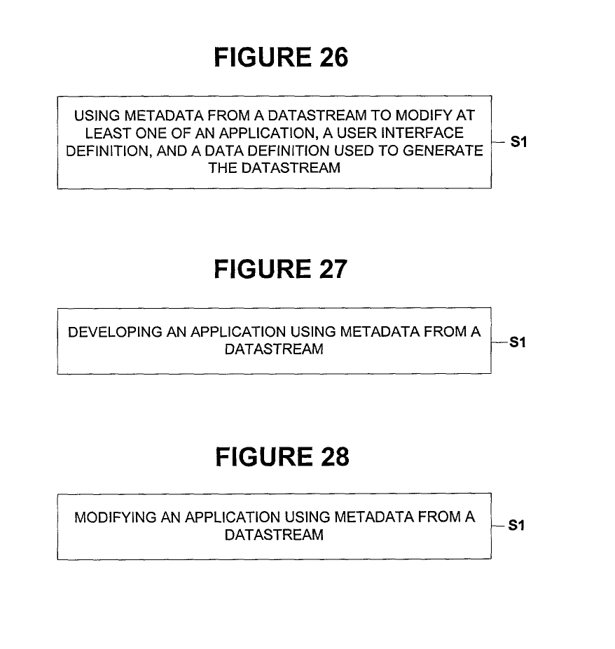

FIG. 26 is a method comprising using metadata from a datastream to modify at least one of an application, user interface definition, and a data definition used to generate the datastream. The datastream can be a presentation datastream. Moreover, the metadata used in the method can identify and/or comprise the application, user interface definition, and/or data definition.

FIG. 27 is a method comprising developing an application using metadata from a datastream. The datastream can be a presentation datastream used to render a presentation. The application may or may not be one used in the generation of the datastream. The metadata can identify and/or comprises application definition describing the application describing the application that generated the datastream, the user interface definition used to generate the datastream, and/or the data definition used to generating the datastream.

FIG. 28 is a method comprising modifying an application using the metadata in datastream. The application may or may not be the application that generates the datastream. The datastream can be a presentation datastream. The datastream can identify and/or comprise an application definition, user interface definition, and/or data definition used in the generation of the datastream.

The many features and advantages of the present invention are apparent from the detailed specification and thus, it is intended by the appended claims to cover all such features and advantages of the described methods, apparatuses, system, and articles which follow in the true spirit and scope of the invention. Further, since numerous modifications and changes will readily occur to those of ordinary skill in the art, it is not desired to limit the invention to the exact construction and operation illustrated and described. Accordingly, all suitable modifications and equivalents may be resorted to as falling within the scope of the invention.

1. A method comprising the step of:
a) associating metadata with a presentation datastream.

2. A method as claimed in claim 1 further comprising the step of:
b) using the metadata to extract at least one element from the presentation datastream by an application to process the data.

3. A method as claimed in claim 2 wherein the presentation datastream is used to render a presentation, and the application processes the data for a purpose other than rendering the presentation.

4. A method as claimed in claim 2 wherein the presentation datastream is used to generate a presentation, and the application processes the data for a purpose other than rendering the presentation.

5. A method as claimed in claim 1 further comprising the step of:
b) using the metadata to extract at least one element from the presentation datastream for storage in a data storage unit.

6. A method as claimed in claim 5 wherein the element of the presentation datastream is used to render a presentation, and the element is stored in the data storage unit for a purpose other than rendering the presentation.

7. A method as claimed in claim 5 wherein the presentation datastream is not used to generate a presentation, and the data storage unit stores the element for a purpose other than rendering the presentation.

8. A method as claimed in claim 1 wherein the metadata identifies an application that generated the presentation datastream.

9. A method as claimed in claim 8 wherein an application generates the presentation datastream, and the metadata identifies a memory location of the application in a computing environment.

10. A method as claimed in claim 8 wherein the metadata identifies a purpose of the application.

11. A method as claimed in claim 1 wherein the metadata identifies a data definition defining data used to generate the presentation datastream.

12. A method as claimed in claim 11 wherein the metadata identifies a field length of data stored in the data storage unit.

13. A method as claimed in claim 11 wherein the metadata identifies a data type of the presentation data stored in the data storage unit.

14. A method as claimed in claim 11 wherein the metadata identifies a variable name associated with data.

15. A method as claimed in claim 11 wherein the metadata defines permissible values for the presentation data.

16. A method as claimed in claim 15 wherein the metadata identifies the permissible values for the presentation data as a range of values.

17. A method as claimed in claim 15 wherein the metadata identifies the permissible values for the presentation data as a group of permissible values.

18. A method as claimed in claim 1 wherein the metadata identifies a user interface definition for the presentation data.

19. A method as claimed in claim 18 wherein the user interface definition includes a name of the data rendered on the user interface, and the metadata identifies the name.

20. A method as claimed in claim 18 wherein the user interface definition identifies screen position of data on a user interface display screen, and the metadata identifies the screen position.

21. A method as claimed in claim 20 wherein the screen position is indicated by character row and column on the user interface display screen, and the metadata identifies the row and column of respective data.

22. A method as claimed in claim 20 wherein the user interface definition includes a variable name associated with a data value, and the metadata identifies the variable name and data value.

23. A method as claimed in claim 20 wherein the metadata identifies a screen to which the presentation data pertains.

24. A method as claimed in claim 1 wherein the presentation datastream includes an instruction and data, the instruction indicating the display position of the data in a presentation, and the data indicating at least one character for rendering in the presentation, the metadata associated with the instruction and data.

25. A method as claimed in claim 1 further comprising the step of:
b) obtaining the metadata.

26. A method as claimed in claim 25 wherein the metadata is obtained by using a mapping of elements in the presentation datastream to corresponding metadata.

27. A method as claimed in claim 25 wherein the metadata is obtained by using a mapping of elements in the presentation datastream to corresponding metatags, and applying the corresponding metatags to the elements of the presentation datastream.

28. A method as claimed in claim 27 wherein the metadata is generated in step (b) as an eXstensible Markup Language (XML) document.

29. A method as claimed in claim 1 further comprising the step of:
b) using the metadata to modify at least one of an application, a user interface definition, and a data definition used to generate the presentation datastream.

30. A method as claimed in claim 1 further comprising the step of:
b) developing an application using the metadata in the datastream.

31. A method as claimed in claim 1 further comprising the step of:
b) modifying an application using the metadata in the datastream.

32. A method comprising the step of:
a) using metadata in a first datastream in a context of a first computing environment to map at least one element of the first datastream to a corresponding element of a second datastream in a context of a second computing environment.

33. A method as claimed in claim 32 wherein the mapped element of the second datastream is used for a purpose other than to render a presentation.

34. A method as claimed in claim 32 wherein the mapped element of the second datastream is provided to an application for processing thereof.

35. A method as claimed in claim 34 wherein the mapped element is used to render a presentation, and the element is provided to the application that processes the element for a purpose other than to render the presentation.

36. A method as claimed in claim 34 wherein the mapped element of the second datastream is not used to render a presentation, and the application processes the element for a purpose other than to render the presentation.

37. A method as claimed in claim 32 wherein the mapped element of the second datastream is provided to a data storage unit for storage.

38. A method as claimed in claim 37 wherein the mapped element of the second datastream is used to render a presentation, and the mapped element is provided to the data storage unit for storage for a purpose other than to render a presentation.

39. A method as claimed in claim 37 wherein the mapped element of the second datastream is not used to render a presentation, and the mapped element of the second datastream is provided to the data storage unit for a purpose other than to render the presentation.

40. A method as claimed in claim 32 wherein the first and second datastreams are presentation datastreams.

41. A method as claimed in claim 40 wherein the presentation datastreams include at least one instruction and data, the instruction indicating a screen display position of the data in a presentation, and the data indicating at least one character for rendering in the presentation at the screen position indicated by the instruction, the metadata used to map the instruction and data of the first datastream to corresponding instruction and data of the second datastream.

42. A method as claimed in claim 40 wherein the first datastream is one of VT52, VT100, VT220-78, VT220-8, VT320-7, VT320-8, VT420-7, VT420-8, VT525-7, VT525-8, 3270, 5250, 3270E, 5250E, TN3270E, TN5250E, TDG, SCO ANSI, BBS ANSI, AT 386, AIXTERM, WYSE 50, WYSE 60, TVI 925, and TVI 950 terminal datastreams, and the second datastream is one of HTTP, SGML, HTML, DHTML, XML, WML, WAP, tagging language, and byte code datastreams.

43. A method as claimed in claim 32 wherein the metadata identifies an application that generated the first datastream.

44. A method as claimed in claim 32 wherein an application generates the first datastream, and the metadata identifies a memory location of the application in the first computing environment.

45. A method as claimed in claim 32 wherein an application generates the first datastream, and the metadata identifies a purpose of the application.

46. A method as claimed in claim 32 wherein the metadata identifies a data definition defining data used to generate the first datastream.

47. A method as claimed in claim 46 wherein the metadata identifies a field length of the data.

48. A method as claimed in claim 46 wherein the metadata identifies a type of the data.

49. A method as claimed in claim 46 wherein the metadata identifies a variable name associated with the data.

50. A method as claimed in claim 46 wherein the metadata defines permissible values for the data.

51. A method as claimed in claim 50 wherein the metadata identifies the permissible values for the data as a range of values.

52. A method as claimed in claim 51 wherein the metadata identifies the permissible values for the presentation data as a group of permissible values.

53. A method as claimed in claim 32 wherein the metadata identifies a user interface definition.

54. A method as claimed in claim 53 wherein the user interface definition includes a variable name of data to be rendered in a presentation based on the second datastream.

55. A method as claimed in claim 53 wherein the user interface definition identifies screen position of data on a user interface display screen in a presentation to be rendered by the second datastream, and the metadata identifies the screen position of the data.

56. A method as claimed in claim 55 wherein the screen position is indicated by character row and column on the user interface display screen of a presentation rendered by the second datastream, and the metadata identifies the row and column of the respective data.

57. A method as claimed in claim 32 wherein the user interface definition includes a variable name associated with a data value, and the metadata identifies the variable name and data value.

58. A method as claimed in claim 32 wherein the metadata identifies a presentation screen rendered based on the second datastream.

59. A method comprising the steps of:
a) using metadata to extract elements of a presentation datastream; and
b) using the extracted elements by processing or storing the extracted elements in addition to rendering the presentation.

60. A method comprising the steps of:
a) generating a first datastream in a context of a first computing environment;
b) associating metadata with the first datastream to produce a second datastream;
c) transmitting the second datastream to a second computing environment;
d) receiving the second datastream at the second computing environment;
e) transforming the second datastream into a third datastream using the metadata, the third datastream in the context of a third computing environment; and
f) transmitting the third datastream to the third computing environment.

61. A method as claimed in claim 60 wherein the first and second datastreams are presentation datastreams.

62. A method as claimed in claim 60 wherein the third datastream is used for a purpose other than to render a presentation.

63. A method as claimed in claim 60 wherein the third datastream is provided to an application for processing.

64. A method as claimed in claim 63 wherein the third datastream is used to render a presentation, and the application processes the third datastream for a purpose other than to render a presentation.

65. A method as claimed in claim 63 wherein the third datastream is not used to render a presentation, and the application processes the third datastream for a purpose other than to render the presentation.

67. A method as claimed in claim 63 wherein the third datastream is provided to a data storage unit for storage.

68. A method as claimed in claim 67 wherein the third datastream is used to render a presentation, and the third datastream is stored in the data storage unit for a purpose other than to render the presentation.

69. A method as claimed in claim 67 wherein the third datastream is not used to render a presentation, and the third datastream is stored in the data storage unit for a purpose other than to render the presentation.

70. A method as claimed in claim 60 wherein the first datastream is one of VT52, VT100, VT220-78, VT220-8, VT320-7, VT320-8, VT420-7, VT420-8, VT525-7, VT525-8, 3270, 5250, 3270E, 5250E, TN3270E, TN5250E, TDG, SCO ANSI, BBS ANSI, AT 386, AIXTERM, WYSE 50, WYSE 60, TVI 925, and TVI 950 terminal datastreams, and the third datastream is one of HTTP, SGML, HTML, DHTML, XML, WML, WAP, tagging language, and byte code datastreams.

71. A method as claimed in claim 60 wherein the presentation datastreams include at least one instruction and data, the instruction indicating a screen display position of the data in a presentation, and the data indicating at least one character for rendering in the presentation at the screen position indicated by the instruction, the metadata used to map the instruction and data of the first datastream to corresponding instruction and data of the third datastream.

72. A method comprising the step of:
a) associating metadata with an interactive datastream.

73. A method as claimed in claim 72 wherein the interactive datastream is generated by computing environments that communicate with one another.

74. A method as claimed in claim 72 wherein the metadata is associated with at least one element of the datastream to identify the element so as to permit transformation of the element from a context of one computing environment to a context of another computing environment.

75. A method as claimed in claim 72 wherein a first computing environment executes an application to generate at least one element of the datastream, and a second computing environment renders a presentation using the transformed element.

76. A method as claimed in claim 72 wherein the first computing environment executes a first application to generate at least one element of the datastream, and the second computing environment executes a second application using the transformed element of the datastream.

77. A method as claimed in claim 72 wherein the first computing environment executes an application to generate at least one element of the datastream, and the second computing environment stores the transformed element in a data storage unit.

78. A computing environment executing a metadata module to associate metadata with a presentation datastream.

79. A computing environment as claimed in claim 78 wherein the metadata module associates the metadata with the presentation datastream to permit another computing environment to use the element from the presentation datastream for a purpose other than to render a presentation.

80. A computing environment as claimed in claim 78 wherein the metadata module associates the metadata with the presentation datastream so that at least one element of the presentation datastream can be used by an application executed in another computing environment.

81. A computing environment as claimed in claim 80 wherein the application processes the presentation datastream for a purpose other than to render a presentation.

82. A computing environment as claimed in claim 80 wherein the presentation datastream is used to render a presentation, and the application processes the presentation for a purpose other than to render the presentation.

83. A computing environment as claimed in claim 80 wherein the presentation datastream is not used to render a presentation, and the application processes the presenation for a purpose other than to render the presentation.

84. A computing environment as claimed in claim 72 wherein the metadata module associates the metadata with the presentation datastream so that at least one element of the presentation datastream can be stored in a data storage unit of another computing environment.

85. A computing environment as claimed in claim 84 wherein the element is used to render a presentation, and the presentation datastream is stored in the data storage unit for a purpose other than to render a presentation.

86. A computing environment as claimed in claim 84 wherein the element of the presentation datastream is not used to render a presentation and the element is stored in the data storage unit for a purpose other than to render a presentation.

87. A computing environment as claimed in claim 72 wherein the metadata identifies an application that generated the presentation data.

88. A computing environment as claimed in claim 72 wherein the metadata identifies a memory location of the application in a computing environment.

89. A computing environment as claimed in claim 72 wherein the metadata identifies a purpose of the application.

90. A computing environment as claimed in claim 72 wherein the metadata identifies a data definition defining data used to generate the presentation datastream.

91. A computing environment as claimed in claim 72 wherein the metadata identifies a field length of data stored in the data storage unit.

92. A computing environment as claimed in claim 72 wherein the metadata identifies a data type of the data stored in the data storage unit.

93. A computing environment as claimed in claim 72 wherein the metadata identifies a variable name associated with data.

94. A computing environment as claimed in claim 72 wherein the metadata defines permissible values for the data.

95. A computing environment as claimed in claim 94 wherein the metadata identifies the permissible values for the data as a range of values.

96. A computing environment as claimed in claim 94 wherein the metadata identifies the permissible values for the data as a group of permissible values.

97. A computing environment as claimed in claim 72 wherein the metadata identifies a user interface definition for the data.

98. A computing environment as claimed in claim 97 wherein the user interface definition includes a variable identifying the data in the datastream to be rendered on the user interface, and the metadata identifies the name.

99. A computing environment as claimed in claim 97 wherein the user interface definition identifies screen position of data on a user interface display screen, and the metadata identifies the screen position.

100. A computing environment as claimed in claim 97 wherein the screen position is indicated by character row and column on the user interface display screen, and the metadata identifies the character row and column of respective data in the presentation datastream.

101. A computing environment as claimed in claim 97 wherein the user interface definition includes a variable name associated with a data value, and the metadata identifies the variable name and data value.

102. A computing environment as claimed in claim 97 wherein the metadata identifies a screen to which the presentation datastream pertains.

103. A computing environment as claimed in claim 72 wherein the presentation datastream includes an instruction and data, the instruction indicating the display position of the data in a presentation, and the data indicating at least one character for rendering in the presentation, the metadata associated with the instruction and data.

104. A computing environment as claimed in claim 72 wherein the metadata module obtains the metadata from a memory device in the computing environment.

105. A computing environment as claimed in claim 72 wherein the metadata module generates the metadata using metatags and a mapping of elements of the presentation datastream to corresponding metatags, and applying the corresponding metatags to corresponding data in the presentation datastream.

106. A computing environment as claimed in claim 72 wherein the metadata is included with the presentation datastream in an eXstensible Markup Language (XML) document.

107. A computing environment receiving a first datastream having metadata, the computing environment comprising a metadata interpreter using the metadata in the first datastream to map at least one element of the first datastream to a corresponding element of a second datastream.

108. A computing environment as claimed in claim 107 wherein the second datastream is used for a purpose other than to render a presentation.

109. A computing environment as claimed in claim 107 wherein the second datastream is provided to an application for processing.

110. A computing environment as claimed in claim 109 wherein the second datastream is used to render a presentation and the application processes the second datastream for a purpose other than to render a presentation.

111. A computing environment as claimed in claim 109 wherein the second datastream is not used to render a presentation and the application processes the second datastream for a purpose other than to render a presentation.

112. A computing environment as claimed in claim 111 wherein the second datastream is provided to a data storage unit for storage.

113. A computing environment as claimed in claim 112 wherein the second datastream is used to render a presentation, and the data storage unit stores the second datastream for a purpose other than to render the presentation.

114. A computing environment as claimed in claim 112 wherein the second datastream is not used to render a presentation, and the data storage unit stores the second datastream for a purpose other than to render the presentation.

115. A computing environment as claimed in claim 107 wherein the first and second datastreams are presentation datastreams.

116. A computing environment as claimed in claim 115 wherein the presentation datastreams include at least one instruction and data, the instruction indicating a screen display position of the data in a presentation, and the data indicating at least one character for rendering in the presentation at the screen position indicated by the instruction, the metadata used to map the instruction and data of the first datastream to corresponding instruction and data of the second datastream.

117. A computing environment as claimed in claim 107 wherein the first datastream is one of VT52, VT100, VT220-78, VT220-8, VT320-7, VT320-8, VT420-7, VT420-8, VT525-7, VT525-8, 3270, 5250, 3270E, 5250E, TN3270E, TN5250E, TDG, SCO ANSI, BBS ANSI, AT 386, AIXTERM, WYSE 50, WYSE 60, TVI 925, and TVI 950 terminal datastreams, and the second datastream is one of HTTP, SGML, HTML, DHTML, XML, WML, WAP, tagging language, and byte code datastreams.

118. A computing environment as claimed in claim 107 wherein the metadata identifies an application that generated the first datastream.

119. A computing environment as claimed in claim 107 wherein the metadata identifies a memory location of the application in its computing environment.

120. A computing environment as claimed in claim 107 wherein the metadata identifies a purpose of the application.

121. A computing environment as claimed in claim 107 wherein the metadata identifies a data definition defining data used to generate the first datastream.

122. A computing environment as claimed in claim 107 wherein the metadata identifies a field length of the data.

123. A computing environment as claimed in claim 107 wherein the metadata identifies a type of the data.

124. A computing environment as claimed in claim 107 wherein the metadata identifies a variable name associated with the data.

125. A computing environment as claimed in claim 107 wherein the metadata defines permissible values for the data.

126. A computing environment as claimed in claim 125 wherein the metadata identifies the permissible values for the data as a range of values.

127. A computing environment as claimed in claim 125 wherein the metadata identifies the permissible values for the presentation data as a group of permissible values.

128. A computing environment as claimed in claim 107 wherein the metadata identifies a user interface definition.

129. A computing environment as claimed in claim 128 wherein the user interface definition includes a variable name of data to be rendered in a presentation based on the second datastream.

130. A computing environment as claimed in claim 128 wherein the user interface definition identifies screen position of data on a user interface display screen in a presentation rendered by the second datastream, and the metadata identifies the screen position of the data.

131. A computing environment as claimed in claim 130 wherein the screen position is indicated by character row and column on the user interface display screen of a presentation rendered by the second datastream, and the metadata identifies the row and column of the respective data.

132. A computing environment as claimed in claim 130 wherein the user interface definition includes a variable name associated with a data value, and the metadata identifies the variable name and data value.

133. A computing environment as claimed in claim 107 wherein the metadata identifies a presentation screen to be rendered with the second datastream.

134. A system receiving a first datastream, the system comprising:
a first computing environment executing a metadata module to associate metadata with the first datastream to generate a second datastream;
a second computing environment coupled to receive the second datastream from the first computing environment, the second computing environment executing a metadata interpreter to map the metadata associated with at least one element of the second datastream to at least one corresponding element of a third datastream, to generate the third datastream.

135. A system as claimed in claim 134 further comprising:
a computing device coupled to receive the third datastream and rendering a presentation based thereon.

136. A system as claimed in claim 134 wherein the first datastream is generated by a host computer, and the computing device renders a presentation that emulates a terminal device corresponding to the first datastream.

137 A system as claimed in claim 134 wherein the first datastream is one of VT52, VT100, VT220-78, VT220-8, VT320-7, VT320-8, VT420-7, VT420-8, VT525-7, VT525-8, 3270, 5250, 3270E, 5250E, TN3270E, TN5250E, TDG, SCO ANSI, BBS ANSI, AT 386, AIXTERM, WYSE 50, WYSE 60, TVI 925, and TVI 950 terminal datastreams, and the third datastream is one of HTTP, SGML, HTML, DHTML, XML, WML, WAP, tagging language, and byte code datastreams.

138. A system as claimed in claim 134 wherein the first datastream is a presentation datastream and the third datastream is not a presentation datastream.

139. A system as claimed in claim 134 wherein the third datastream is used by an application executed on a computing device for processing the third datastream.

140. A system as claimed in claim 139 wherein the third datastream is used to render a presentation, and the application is executed by the computing device for a purpose other than to render the presentation.

141. A system as claimed in claim 139 wherein the third datastream is not used to render a presentation, and the application is executed by the computing device for a purpose other than to render the presentation.

142. A system as claimed in claim 134 wherein the third datastream is supplied to a data storage unit for storage of data contained therein.

143. A system as claimed in claim 142 wherein the third datastream is used to render a presentation, and the data storage unit stores the third datastream for a purpose other than to render the presentation.

144. A system as claimed in claim 142 wherein the third datastream is not used to render a presentation, and the data storage unit stores the third datastream for a purpose other than to render a presentation.

145. A computer-readable medium storing a metadata module for associating metadata with a presentation datastream.

146. A computer-readable medium as claimed in claim 145 wherein the computer-readable medium stores metadata for use by the metadata module.

147. A computer-readable medium as claimed in claim 145 wherein the metadata identifies an application that generated the presentation data.

148. A computer-readable medium as claimed in claim 145 wherein an application generates the presentation datastream, and the metadata identifies a memory location of the application in a computing environment.

149. A computer-readable medium as claimed in claim 145 wherein the metadata identifies a purpose of the application.

150. A computer-readable medium as claimed in claim 145 wherein the metadata identifies a data definition defining data used to generate the presentation datastream.

151. A computer-readable medium as claimed in claim 145 wherein the metadata identifies a field length of data stored in the data storage unit.

152. A computer-readable medium as claimed in claim 143 wherein the metadata identifies a data type of the presentation data stored in the data storage unit.

153. A computer-readable medium as claimed in claim 143 wherein the metadata identifies a variable name associated with data.

154. A computer-readable medium as claimed in claim 143 wherein the metadata defines permissible values for the presentation data.

155. A computer-readable medium as claimed in claim 143 wherein the metadata identifies the permissible values for the presentation data as a range of values.

156. A computer-readable medium as claimed in claim 143 wherein the metadata identifies the permissible values for the presentation data as a group of permissible values.

157. A computer-readable medium as claimed in claim 143 wherein the metadata identifies a user interface definition for the presentation data.

158. A computer-readable medium as claimed in claim 157 wherein the user interface definition includes a variable name of the data rendered on the user interface, and the metadata identifies the variable name.

159. A computer-readable medium as claimed in claim 157 wherein the user interface definition identifies screen position of data on a user interface display screen, and the metadata identifies the screen position.

160. A computer-readable medium as claimed in claim 157 wherein the screen position is indicated by character row and column on the user interface display screen, and the metadata identifies the row and column of respective data.

161. A computer-readable medium as claimed in claim 157 wherein the user interface definition includes a variable name associated with a data value, and the metadata identifies the variable name and data value.

162. A computer-readable medium as claimed in claim 157 wherein the metadata identifies a screen to which the presentation data pertains.

163. A computer-readable medium as claimed in claim 157 wherein the presentation datastream includes an instruction and data, the instruction indicating the display position of the data in a presentation, and the data indicating at least one character for rendering in the presentation, the metadata associated with the instruction and data.

164. A computer-readable medium as claimed in claim 157 wherein the metadata module obtains the metadata using a mapping of elements in the presentation datastream to corresponding metadata.

165. A computer-readable medium as claimed in claim 157 wherein the metadata module uses a mapping of at least one element in the presentation datastream to at least one corresponding metatag, and applies the corresponding metatag to the element of the presentation datastream.

166. A computer-readable medium comprising a metadata interpreter using metadata in a first datastream in a context of a first computing environment to map at least one element of the first datastream to a corresponding element of a second datastream in a context of a second computing environment.

167. A method as claimed in claim 166 wherein the second datastream is used for a purpose other than to render a presentation.

168. A method as claimed in claim 166 wherein the second datastream is provided to an application for processing thereof.

169. A method as claimed in claim 166 wherein the second datastream is used to render a presentation, and the application processes the second datastream for a purpose other than to render the presentation.

170. A method as claimed in claim 166 wherein the second datastream is not used to render a presentation, and the application processes the second datastream for a purpose other than to render the presentation.

171. A method as claimed in claim 166 wherein the second datastream is provided to a data storage unit for storage.

172. A method as claimed in claim 166 wherein the first and second datastreams are presentation datastreams.

173. A method as claimed in claim 172 wherein the first datastream is one of VT52, VT100, VT220-78, VT220-8, VT320-7, VT320-8, VT420-7, VT420-8, VT525-7, VT525-8, 3270, 5250, 3270E, 5250E, TN3270E, TN5250E, TDG, SCO ANSI, BBS ANSI, AT 386, AIXTERM, WYSE 50, WYSE 60, TVI 925, and TVI 950 terminal datastreams, and the second datastream is one of HTTP, SGML, HTML, DHTML, XML, WML, WAP, tagging language, and byte code datastreams.

174. A method as claimed in claim 172 wherein the presentation datastreams include at least one instruction and data, the instruction indicating a screen display position of the data in a presentation, and the data indicating at least one character for rendering in the presentation at the screen position indicated by the instruction, the metadata used to map the instruction and data of the first datastream to corresponding instruction and data of the second datastream.

175. A method as claimed in claim 172 wherein the metadata identifies an application that generated the first datastream.

176. A method as claimed in claim 164 wherein an application generates the first datastream, and the metadata identifies a memory location of the application in the first computing environment.

177. A method as claimed in claim 166 wherein the metadata identifies a purpose of the application that generates the first datastream.

178. A method as claimed in claim 166 wherein the metadata identifies a data definition defining data used to generate the first datastream.

179. A method as claimed in claim 166 wherein the metadata identifies a field length of the data.

180. A method as claimed in claim 166 wherein the metadata identifies a type of the data.

181. A method as claimed in claim 166 wherein the metadata identifies a variable name associated with the data.

182. A method as claimed in claim 166 wherein the metadata defines permissible values for the data.

183. A method as claimed in claim 182 wherein the metadata identifies the permissible values for the data as a range of values.

184. A method as claimed in claim 183 wherein the metadata identifies the permissible values for the presentation data as a group of permissible values.

185. A method as claimed in claim 166 wherein the metadata identifies a user interface definition.

186. A method as claimed in claim 185 wherein the user interface definition includes a variable name of data to be rendered in a presentation based on the second datastream.

187. A method as claimed in claim 185 wherein the user interface definition identifies screen position of data on a user interface display screen in a presentation to be rendered by the second datastream, and the metadata identifies the screen position of the data.

188. A method as claimed in claim 185 wherein the screen position is indicated by character row and column on the user interface display screen of a presentation rendered by the second datastream, and the metadata identifies the row and column of the respective data.

189. A method as claimed in claim 185 wherein the user interface definition includes a variable name associated with a data value, and the metadata identifies the variable name and data value.

190. A method as claimed in claim 185 wherein the metadata identifies a presentation screen rendered by the second datastream.

191. A method comprising the step of:
a) using metadata in a datastream to modify at least one of an application, a user interface definition, and a data definition, used to generate the datastream.

192. A method as claimed in claim 191 wherein the datastream comprises a presentation datastream.

193. A method as claimed in claim 191 wherein the metadata identifies the application.

194. A method as claimed in claim 191 wherein the metadata comprises application definition.

195. A method as claimed in claim 191 wherein the metadata identifies the user interface definition.

196. A method as claimed in claim 191 wherein the metadata comprises the user interface definition.

197. A method as claimed in claim 191 wherein the metadata identifies the data definition.

198. A method as claimed in claim 191 wherein the metadata comprises the data definition.

199. A method comprising the step of:
a) developing an application using metadata in a datastream.

200. A method as claimed in claim 199 wherein the datastream comprises a presentation datastream.

201. A method as claimed in claim 199 wherein the metadata identifies the application.

202. A method as claimed in claim 199 wherein the metadata identifies another application used to generate the datastream.

203. A method as claimed in claim 199 wherein the metadata comprises application definition describing the application.

204. A method as claimed in claim 199 wherein the metadata identifies a user interface definition used to generate the datastream.

205. A method as claimed in claim 199 wherein the metadata comprises a user interface definition used to generate the datastream.

206. A method as claimed in claim 199 wherein the metadata identifies a data definition used to generate the datastream.

207. A method as claimed in claim 199 wherein the metadata comprises a data definition used to generate the datastream.

208. A method comprising the step of:
b) modifying an application using the metadata in datastream.

209. A method as claimed in claim 208 wherein the datastream comprises a presentation datastream.

210. A method as claimed in claim 208 wherein the metadata identifies the application.

211. A method as claimed in claim 208 wherein the metadata identifies another application used to generate the datastream.

212. A method as claimed in claim 208 wherein the metadata comprises application definition used to generate the datastream.

213. A method as claimed in claim 208 wherein the metadata identifies a user interface definition used to generate the datastream.

214. A method as claimed in claim 208 wherein the metadata comprises a user interface definition used to generate the datastream.

215. A method as claimed in claim 208 wherein the metadata identifies a data definition used to generate the datastream.

216. A method as claimed in claim 208 wherein the metadata comprises a data definition used to generate the datastream.
